(19) United States
(12) Patent Application Publication
(10) Pub. No.: US 2020/0201913 A1
(43) Pub. Date: Jun. 25, 2020

(54) SYSTEMS AND METHODS FOR IMPROVED AUTOMATED CONVERSATIONS WITH ROI METRICS AND THRESHOLD ANALYSIS

(71) Applicant: Conversica, Inc., Foster City, CA (US)

(72) Inventors: George Alexis Terry, Woodside, CA (US); Werner Koepf, Seattle, WA (US); William Dominic Webb-Purkis, San Francisco, CA (US); James D. Harriger, Duvall, WA (US); Christopher Allan Long, Seattle, WA (US); Will Kempff Beeler, Seattle, WA (US); Gabriel Vincent Martini, Bellingham, WA (US); Claudia Elena Robles, Edmonds, WA (US); Paul Harrison Williams, Bellingham, WA (US)

(21) Appl. No.: 16/718,038

(22) Filed: Dec. 17, 2019

Related U.S. Application Data
(63) Continuation-in-part of application No. 16/019,382, filed on Jun. 26, 2018.
Application No. 16/019,382 is a continuation-in-part of application No. 14/604,610, filed on Jan. 23, 2015, now Pat. No. 10,026,037.
Application No. 14/604,610 is a continuation-in-part of application No. 14/604,602, filed on Jan. 23, 2015.
Application No. 14/604,602 is a continuation-in-part of application No. 14/604,594, filed on Jan. 23, 2015.
(60) Provisional application No. 62/783,198, filed on Dec. 20, 2018.

(51) Int. Cl. G06F 16/9032; G06F 16/9038; G06F 40/56; G06Q 30/02

(52) U.S. Cl. CPC G06F 16/90332; G06Q 30/0281; G06F 40/56; G06F 16/9038

(57) ABSTRACT

Systems and methods for setting service appointments in an automated conversation system, ensuring data fidelity, return on investment (ROI) analysis, accelerating response times, and scraping third party system to populate the conversation system are all provided. These systems and methods automatically schedules appointments for services, and performs all necessary follow-up activity, ensures target duplication isn't present in conversations, ensures that representatives are incorporated into the system, enhances speeds by altering processing, response generation and sending queues if timing won't meet goals, presents suitably noteworthy ROI metrics and scrapes a third party databases using phantom scripts. All this activity improves the automated conversation experience, and its ability to effectuate business objectives.

### CROSS REFERENCE TO RELATED APPLICATIONS

This continuation-in-part application is a non-provisional and claims the benefit of U.S. provisional application of the same title, U.S. provisional application No. 62/783,198, Attorney Docket No. CVSC-18H-P, filed in the USPTO on Dec. 20, 2018, currently pending.

This continuation-in-part application also claims the benefit of U.S. application entitled “Systems and Methods for Natural Language Processing and Classification,” U.S. application Ser. No. 16/019,382, Attorney Docket No. CVSC-17A1-US, filed in the USPTO on Jun. 26, 2018, pending, which is a continuation-in-part application which claims the benefit of U.S. application entitled “Systems and Methods for Configuring Knowledge Sets and AI Algorithms for Automated Message Exchanges,” U.S. application Ser. No. 14/604,610, Attorney Docket No. CVSC-1403, filed in the USPTO on Jan. 23, 2015, now U.S. Pat. No. 10,026,037 issued Jul. 17, 2018. Additionally, U.S. application Ser. No. 16/019,382 claims the benefit of U.S. application entitled “Systems and Methods for Processing Message Exchanges Using Artificial Intelligence,” U.S. application Ser. No. 14/604,602, Attorney Docket No. CVSC-1402, filed in the USPTO on Jan. 23, 2015, pending, and U.S. application entitled “Systems and Methods for Management of Automated Dynamic Messaging,” U.S. application Ser. No. 14/604,594, Attorney Docket No. CVSC-1401, filed in the USPTO on Jan. 23, 2015, pending.

All of the above-referenced applications/patents are incorporated herein in their entirety by this reference.

### BACKGROUND

The present invention relates to systems and methods for natural language processing and generation of more “human” sounding artificially generated conversations. Such natural language processing techniques may be employed in the context of machine learned conversation systems. These conversational AIs include, but are not limited to, message response generation, AI assistant performance, and other language processing, primarily in the context of the generation and management of a dynamic conversations. Such systems and methods provide a wide range of business people more efficient tools for outreach, knowledge delivery, automated task completion, and also improve computer functioning as it relates to processing documents for meaning. In turn, such system and methods enable more productive business conversations and other activities with a majority of tasks performed previously by human workers delegated to artificial intelligence assistants.

Artificial Intelligence (AI) is becoming ubiquitous across many technology platforms. AI enables enhanced productivity and enhanced functionality through “smarter” tools. Examples of AI tools include stock managers, chatbots, and voice activated search-based assistants such as Siri and Alexa. With the proliferation of these AI systems, however, come challenges for user engagement, quality assurance and oversight.

When it comes to user engagement, many people do not feel comfortable communicating with a machine outside of certain discrete situations. A computer system intended to converse with a human is typically considered limiting and frustrating. This has manifested in a deep anger many feel when dealing with automated phone systems, or spammed, non-personal emails.

These attitudes persist even when the computer system being conversed with is remarkably capable. For example, many personal assistants such as Siri and Alexa include very powerful natural language processing capabilities; however, the frustration when dealing with such systems, especially when they do not “get it” persists. Ideally an automated conversational system provides more organic sounding messages in order to reduce this natural frustration on behalf of the user. Indeed, in the perfect scenario, the user interfacing with the AI conversation system would be unaware that they are speaking with a machine rather than another human.

In order for a machine to sound more human or organic includes improvements in natural language processing and the generation of accurate, specific and contextual action to meaning rules.

It is therefore apparent that an urgent need exists for advancements in the natural language processing techniques used by AI conversation systems, including contextual analysis by leveraging speech acts, and through the advanced construction of a rule data base populated by sophisticated recommendations. Such systems and methods allow for improved conversations and for added functionalities.

### SUMMARY

To achieve the foregoing and in accordance with the present invention, systems and methods for natural language processing, automated conversations, and enhanced system functionality are provided. Such systems and methods allow for more effective AI operations, improvements to the experience of a conversation target, and increased productivity through AI assistance.

In some embodiments, systems and methods are provided for setting service appointments in an automated conversation system. This involves receiving a triggering event (sale, lease, service appointment, etc.) that is used to generate a delay for a service to be undertaken. The system automatically schedules an appointment for the service, and performs all necessary follow-up activity. If a target ever becomes stale then the target gets automatically deactivated from the service setting system. The delays are calculated based upon what the triggering event is, and the service type according to preconfigured rules. Additionally this may cause many appointments to be set, or daisy chained over time.

Other embodiments include data fidelity systems and methods, which perform internal target duplication checks (using exact matching and fuzzy logic matches), as well as external duplication testing across different conversation groups. When targets are duplicated within a conversation exchange, they are de-duplicated. In external conversations, however, the degree of conflict between the conversations in which the target duplicates is first ascertained before there is a conversation termination to eliminate the duplicates. On the flip side, the data fidelity system may also identify internal representatives that are missing in the system from data such as HR feeds, payroll data and from circumstantial evidence (such as email exchanges). New representatives may be added into the workflow, with assignments automatically given to this individual based upon workload leveling.

Other embodiments include return on investment (ROI) analysis systems and methods, which compile metrics for the conversation system to prove its value to clients. The collected metrics include things like total numbers of appointments set, number of targets being actively managed, number of response messages sent, engagement rates, amount of contact information received, and number of messages sent per response. These metric numbers are compared against thresholds, and if above the necessary threshold are eligible for display to the user. Which metrics are to be displayed may be randomized over time, but it is generally beneficial to sort the metrics by those deemed to be most ‘impressive’. This sorting can multiply the sheer numbers of the events by a weight of how important that metric is viewed. The resulting score can be used to sort the metrics for display purposes.

Other embodiments include systems and methods for accelerating response time, which estimate the time required to process a message, generate a response and send the response and compares this against goals for these activities (based upon the communication type). For example a chat goal may be one second for each of these activities, whereas for real-time audio exchanges the goals may be closer to 300 ms or less. When there is a difference between the expected timing and timing goals then it is necessary to truncate processing activity, add resources for message generation and re-order sending queues in order to meet the needed goals. The truncating could include any of limiting a number of models used to classify in the message processing, elimination of entity replacement activity and shifting reliance upon rule based decisions over deep learning analysis. If after all these steps are taken and it is still not possible to meet the timing goals, the system may need to prioritize some message exchanges over others in order to meet the timing requirements of the message exchanges that are deemed a higher priority.

Lastly, other embodiments include systems and methods for scraping third party system to populate the conversation system. Here phantoms are deployed to the third party systems to collect the needed data. The third party system includes customer relationship management (CRM) applications, calendars, resource management software, inventory management software, and email communication systems. The phantoms are scripts which crawl the third party systems for the data. The phantoms are managed by shared phantom classes, which are the logic behind the phantoms' operation. Core functions communicate with the phantoms and direct them through operations directed by the shared phantom class. Control functions define global variables, set time limits for phantoms, and instantiate the core functions. The target in the third party system is identified and a determination is made if target lacks a valid stopclock. Likewise, a determination is made if the target meets stopclock permissions, and if the target is below an age threshold. If so, then stopclock event for the target may be initiated. Lastly, APIs enable the phantoms to communicate with databases and the conversation system.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example logical diagram of a system for generation and implementation of messaging conversations, in accordance with some embodiment;

FIG. 2 is an example logical diagram of a dynamic messaging server, in accordance with some embodiment;

FIG. 3 is an example logical diagram of a user interface within the dynamic messaging server, in accordance with some embodiment;

FIG. 4 is an example logical diagram of a message generator within the dynamic messaging server, in accordance with some embodiment;

FIG. 5A is an example logical diagram of a message response system within the dynamic messaging server, in accordance with some embodiment;

FIG. 5B is an example logical diagram of a message receiver, in accordance with some embodiment;

FIG. 5C is an example logical diagram of a data processor, in accordance with some embodiment;

FIG. 5D is an example logical diagram of a message delivery handler, in accordance with some embodiment;

FIG. 5E is an example logical diagram of an appointment setter, in accordance with some embodiment;

FIG. 5F is an example logical diagram of a specialized service assistant, in accordance with some embodiment;

FIG. 5G is an example logical diagram of a data fidelity engine, in accordance with some embodiment;

FIG. 5H is an example logical diagram of a ROI engine, in accordance with some embodiment;

FIG. 5i is an example logical diagram of a real-time response accelerator, in accordance with some embodiment;

FIG. 5J is an example logical diagram of a scrapper, in accordance with some embodiment;

FIG. 6 is an example flow diagram for a dynamic message conversation, in accordance with some embodiment;

FIG. 7 is an example flow diagram for the process of on-boarding a business actor, in accordance with some embodiment;

FIG. 8 is an example flow diagram for the process of building a business activity such as conversation, in accordance with some embodiment;

FIG. 9 is an example flow diagram for the process of generating message templates, in accordance with some embodiment;

FIG. 10 is an example flow diagram for the process of implementing the conversation, in accordance with some embodiment;

FIG. 11 is an example flow diagram for the process of preparing and sending the outgoing message, in accordance with some embodiment;

FIG. 12 is an example flow diagram for the process of processing received responses, in accordance with some embodiment;

FIG. 13 is an example flow diagram for the process of document cleaning, in accordance with some embodiment;

FIG. 14 is an example flow diagram for message classification, in accordance with some embodiment;

FIG. 15 is an example flow diagram for speech act identification, in accordance with some embodiment;

FIG. 16 is an example flow diagram for entity recognition, in accordance with some embodiment;

FIG. 17 is an example flow diagram for action setting responsive to message meaning, in accordance with some embodiment;

FIG. 18 is an example flow diagram for the process for appointment setting, in accordance with some embodiment;

FIG. 19A is an example flow diagram for the process for specialized service assistant operation, in accordance with some embodiment;

FIGS. 19B-C are example illustrations of service setting timelines, in accordance with some embodiment;

FIG. 20 is an example flow diagram for the process for data fidelity, in accordance with some embodiment;

FIG. 21A is an example flow diagram for the process for ROI analysis, in accordance with some embodiment;

FIG. 21B is an example illustration of an ROI analysis screenshot, in accordance with some embodiment;

FIG. 22 is an example flow diagram for the process for acceleration real-time processing, in accordance with some embodiment;

FIG. 23A is an example flow diagram for the CRM scraping, in accordance with some embodiment;

FIGS. 23B-F are example block diagrams for the scraper logic, in accordance with some embodiment;

FIG. 24 is an example flow diagram for the process for AB testing, in accordance with some embodiment; and

FIGS. 25A and 25B are example illustrations of a computer system capable of embodying the current invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to enhancements to traditional natural language processing techniques and subsequent actions taken by an automated system. While such systems and methods may be utilized with any AI system, such natural language processing particularly excel in AI systems relating to the generation of automated messaging for business conversations such as marketing and other sales functions. While the following disclosure is applicable for other combinations, we will focus upon natural language processing in AI marketing systems as an example, to demonstrate the context within which the enhanced natural language processing excels.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

The following systems and methods are for improvements in natural language processing and actions taken in response to such message exchanges, within conversation systems, and for employment of domain specific assistant systems that leverage these enhanced natural language processing techniques. The goal of the message conversations is to enable a logical dialog exchange with a recipient, where the recipient is not necessarily aware that they are communicating with an automated machine as opposed to a human user. This may be most efficiently performed via a written dialog, such as email, text messaging, chat, etc. However, given the advancement in audio and video processing, it may be entirely possible to have the dialog include audio or video components as well.

In order to effectuate such an exchange, an AI system is employed within an AI platform within the messaging system to process the responses and generate conclusions regarding the exchange. These conclusions include calculating the context of a document, intents, entities, sentiment and confidence for the conclusions. Human operators, through a “training desk” interface, cooperate with the AI to ensure as seamless an experience as possible, even when the AI system is not confident or unable to properly decipher a message. The natural language techniques disclosed herein assist in making the outputs of the AI conversation system more effective, and more ‘human sounding’, which may be preferred by the recipient/target of the conversation.

### I. Dynamic Messaging Systems with Enhanced Natural Language Processing

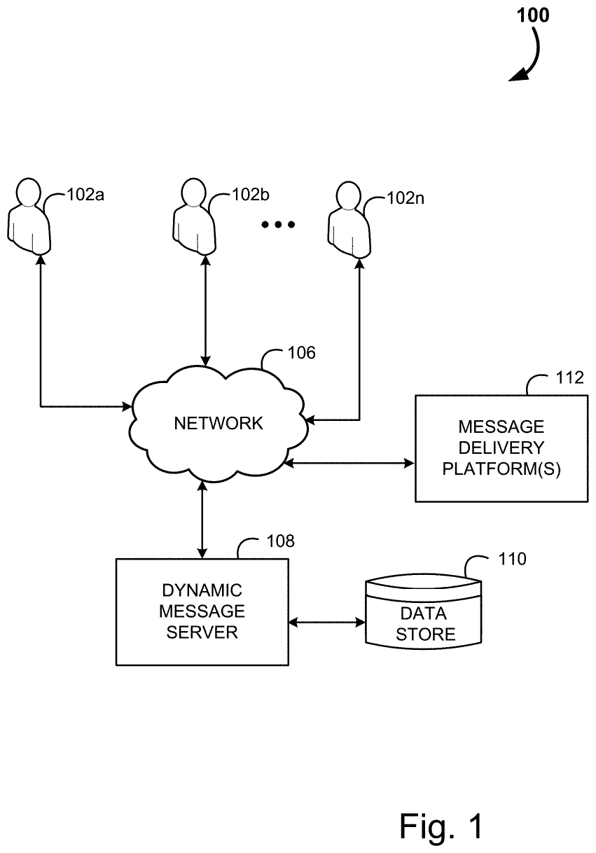

To facilitate the discussion, FIG. 1 is an example logical diagram of a system for generating and implementing messaging conversations, shown generally at 100. In this example block diagram, several users 102a-n are illustrated engaging a dynamic messaging system 108 via a network 106. Note that messaging conversations may be uniquely customized by each user 102a-n in some embodiments. In alternate embodiments, users may be part of collaborative sales departments (or other collaborative group) and may all have common access to the messaging conversations. The users 102a-n may access the network from any number of suitable devices, such as laptop and desktop computers, work stations, mobile devices, media centers, etc.

The network 106 most typically includes the internet but may also include other networks such as a corporate WAN, cellular network, corporate local area network, or combination thereof, for example. The messaging server 108 may distribute the generated messages to the various message delivery platforms 112 for delivery to the individual recipients. The message delivery platforms 112 may include any suitable messaging platform. Much of the present disclosure will focus on email messaging, and in such embodiments the message delivery platforms 112 may include email servers (Gmail, Yahoo, Outlook, etc.). However, it should be realized that the presently disclosed systems for messaging are not necessarily limited to email messaging. Indeed, any messaging type is possible under some embodiments of the present messaging system. Thus, the message delivery platforms 112 could easily include a social network interface, instant messaging system, text messaging (SMS) platforms, or even audio or video telecommunications systems.

One or more data sources 110 may be available to the messaging server 108 to provide user specific information, message template data, knowledge sets, intents, and target information. These data sources may be internal sources for the system's utilization or may include external third-party data sources (such as business information belonging to a customer for whom the conversation is being generated). These information types will be described in greater detail below. This information may be leveraged, in some embodiments, to generate a profile regarding the conversation target. A profile for the target may be particularly useful in a sales setting where differing approaches may yield dramatically divergent outcomes. For example, if it is known that the target is a certain age, with young children, and with an income of $75,000 per year, a conversation assistant for a car dealership will avoid presenting the target with information about luxury sports cars, and instead focus on sedans, SUVs and minivans within a budget the target is likely able to afford. By engaging the target with information relevant to them, and sympathetic to their preferences, the goals of any given conversation are more likely to be met. The external data sources typically relied upon to build out a target profile may include, but are not limited to, credit applications, CRM data sources, public records data sets, loyalty programs, social media analytics, and other “pay to play” data sets, for example.

The other major benefit of a profile for the target is that data that the system “should know” may be incorporated into the conversation to further personalize the message exchange. Information the system “should know” is data that is evident trough the exchange, or the target would expect the AI system would know. Much of the profile data may be public, but a conversation target would feel strange (or even violated) to know that the other party they are communicating with has such a full set of information regarding them. For example, a consumer doesn't typically assume a retailer knows how they voted in the last election, but through an AI conversational system with access to third party data sets, this kind of information may indeed be known. Bringing up such knowledge in a conversation exchange would strike the target as strange, at a minimum, and may actually interfere with achieving the conversation objectives. In contrast, offered information, or information the target assumes the other party has access to, can be incorporated into the conversation in a manner that personalizes the exchange, and makes the conversation more organic sounding. For example if the target mentions having children, and is engaging an AI system deployed for an automotive dealer, a very natural message exchange could include “You mentioned wanting more information on the Highlander SUV. We have a number in stock, and one of our sales reps would love to show you one and go for a test drive. Plus they are great for families. I'm sure your kids would love this car.”

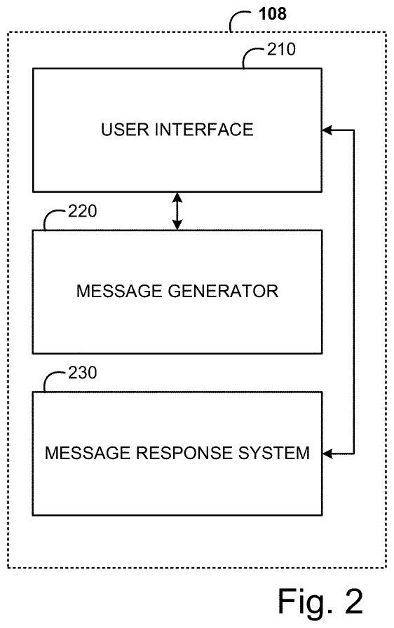

Moving on, FIG. 2 provides a more detailed view of the dynamic messaging server 108, in accordance with some embodiment. The server is comprised of three main logical subsystems: a user interface 210, a message generator 220, and a message response system 230. The user interface 210 may be utilized to access the message generator 220 and the message response system 230 to set up messaging conversations and manage those conversations throughout their life cycle. At a minimum, the user interface 210 includes APIs to allow a user's device to access these subsystems. Alternatively, the user interface 210 may include web accessible messaging creation and management tools.

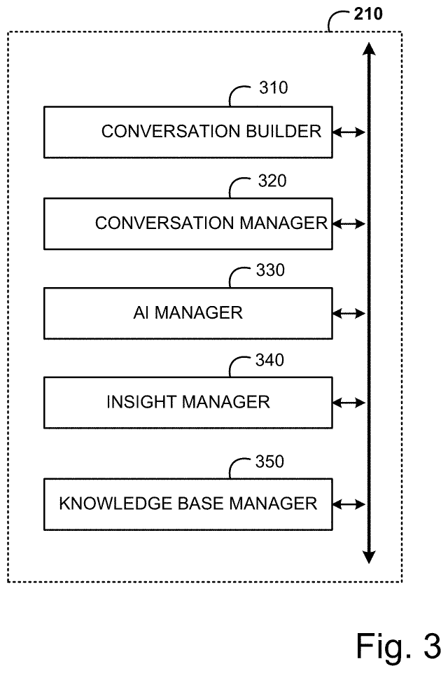

FIG. 3 provides a more detailed illustration of the user interface 210. The user interface 210 includes a series of modules to enable the previously mentioned functions to be carried out in the message generator 220 and the message response system 230. These modules include a conversation builder 310, a conversation manager 320 an AI manager 330, an intent manager 340, and a knowledge base manager 350.

The conversation builder 310 allows the user to define a conversation, and input message templates for each series/exchange within the conversation. A knowledge set and target data may be associated with the conversation to allow the system to automatically effectuate the conversation once built. Target data includes all the information collected on the intended recipients, and the knowledge set includes a database from which the AI can infer context and perform classifications on the responses received from the recipients.

The conversation manager 320 provides activity information, status, and logs of the conversation once it has been implemented. This allows the user 102a to keep track of the conversation's progress, success and allows the user to manually intercede if required. The conversation may likewise be edited or otherwise altered using the conversation manager 320.

The AI manager 330 allows the user to access the training of the artificial intelligence which analyzes responses received from a recipient. One purpose of the given systems and methods is to allow very high throughput of message exchanges with the recipient with relatively minimal user input. To perform this correctly, natural language processing by the AI is required, and the AI (or multiple AI models) must be correctly trained to make the appropriate inferences and classifications of the response message. The user may leverage the AI manager 330 to review documents the AI has processed and has made classifications for.

In some embodiments, the training of the AI system may be enabled by, or supplemented with, conventional CRM data. The existing CRM information that a business has compiled over years of operation is incredibly rich in detail, and specific to the business. As such, by leveraging this existing data set the AI models may be trained in a manner that is incredibly specific and valuable to the business. CRM data may be particularly useful when used to augment traditional training sets, and input from the training desk. Additionally, social media exchanges may likewise be useful as a training source for the AI models. For example, a business often engages directly with customers on social media, leading to conversations back and forth that are again, specific and accurate to the business. As such this data may also be beneficial as a source of training material.

The intent manager 340 allows the user to manage intents. As previously discussed, intents are a collection of categories used to answer some question about a document. For example, a question for the document could include “is the lead looking to purchase a car in the next month?” Answering this question can have direct and significant importance to a car dealership. Certain categories that the AI system generates may be relevant toward the determination of this question. These categories are the ‘intent’ to the question and may be edited or newly created via the intent manager 340. As will be discussed in greater detail below, the generation of questions and associated intents may be facilitated by leveraging historical data via a recommendation engine.

In a similar manner, the knowledge base manager 350 enables the management of knowledge sets by the user. As discussed, a knowledge set is a set of tokens with their associated category weights used by an aspect (AI algorithm) during classification. For example, a category may include “continue contact?”, and associated knowledge set tokens could include statements such as “stop”, “do no contact”, “please respond” and the like.

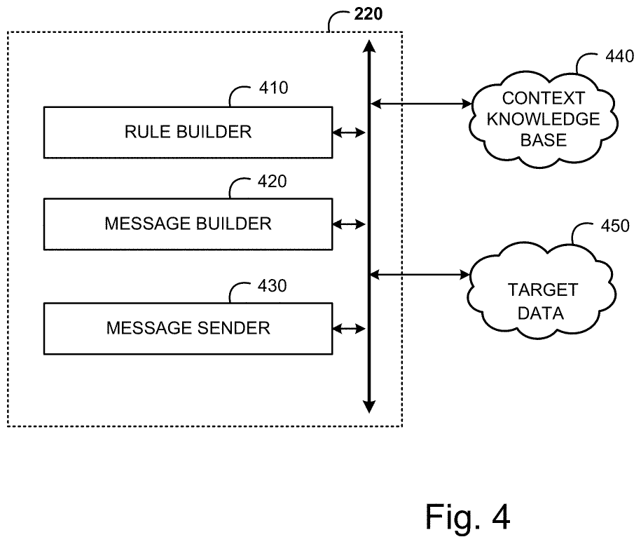

Moving on to FIG. 4, an example logical diagram of the message generator 220 is provided. The message generator 220 utilizes context knowledge 440 and target data 450 to generate the initial message. The message generator 220 includes a rule builder 410 which allows the user to define rules for the messages. A rule creation interface which allows users to define a variable to check in a situation and then alter the data in a specific way. For example, when receiving the scores from the AI, if the intent is Interpretation and the chosen category is ‘good’, then have the Continue Messaging intent return ‘continue’.

The rule builder 410 may provide possible phrases for the message based upon available target data. The message builder 420 incorporates those possible phrases into a message template, where variables are designated, to generate the outgoing message. Multiple selection approaches and algorithms may be used to select specific phrases from a large phrase library of semantically similar phrases for inclusion into the message template. For example, specific phrases may be assigned category rankings related to various dimensions such as “formal vs. informal, education level, friendly tone vs. unfriendly tone, and other dimensions,” Additional category rankings for individual phrases may also be dynamically assigned based upon operational feedback in achieving conversational objectives so that more “successful” phrases may be more likely to be included in a particular message template. Phrase package selection will be discussed in further detail below. The selected phrases incorporated into the template message is provided to the message sender 430 which formats the outgoing message and provides it to the messaging platforms for delivery to the appropriate recipient.

Feedback may be collected from the conversational exchanges, in many embodiments. For example if the goal of a given message exchange is to set up a meeting, and the target agrees to said meeting, this may be counted as successful feedback. However, it may also be desirable to collect feedback from external systems, such as transaction logs in a point of sales system, or through records in a CRM system.

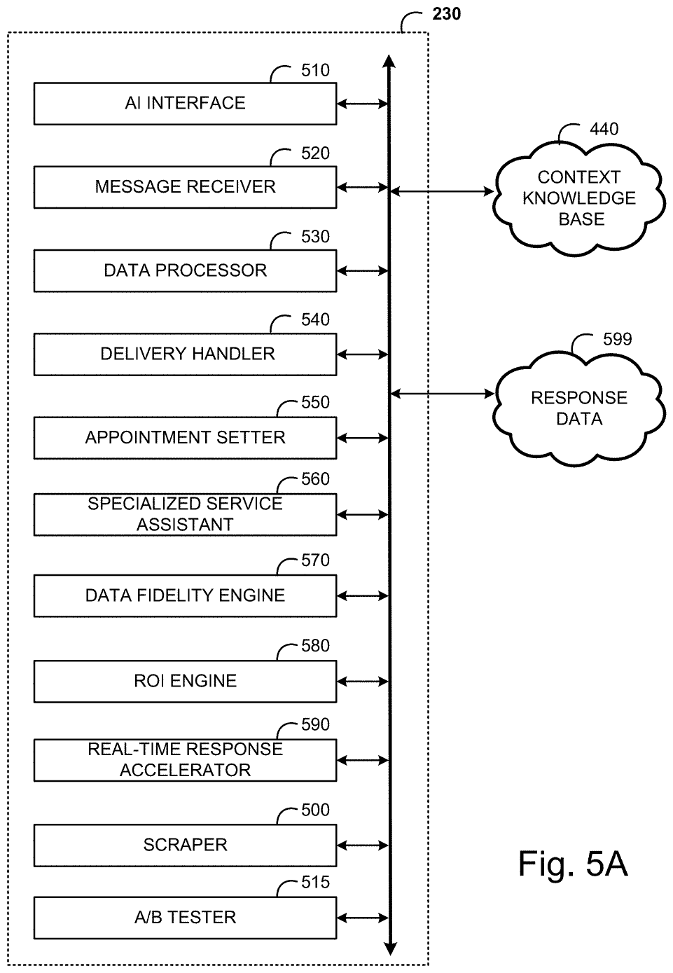

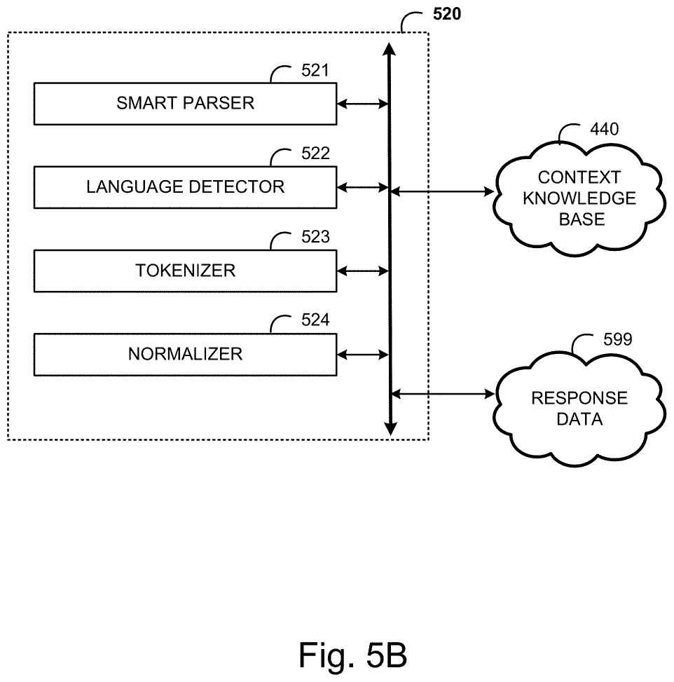

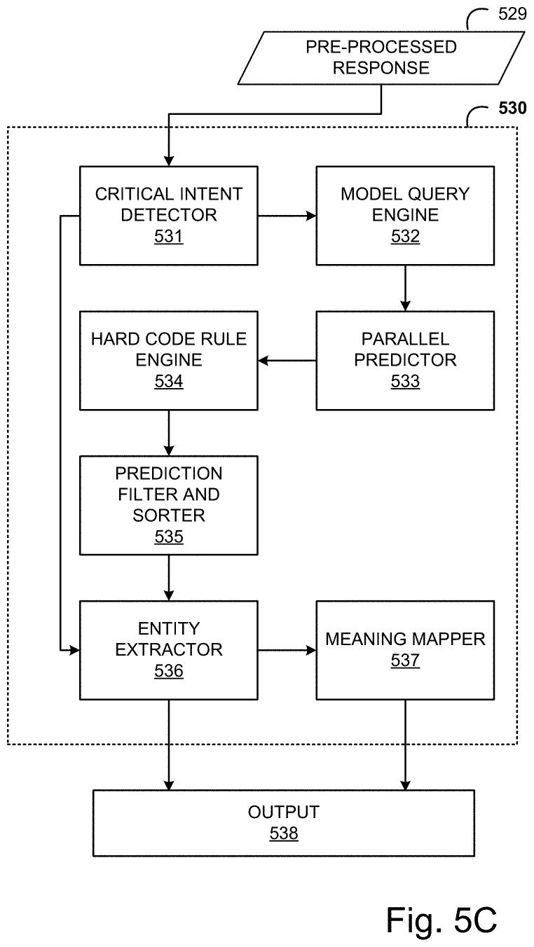

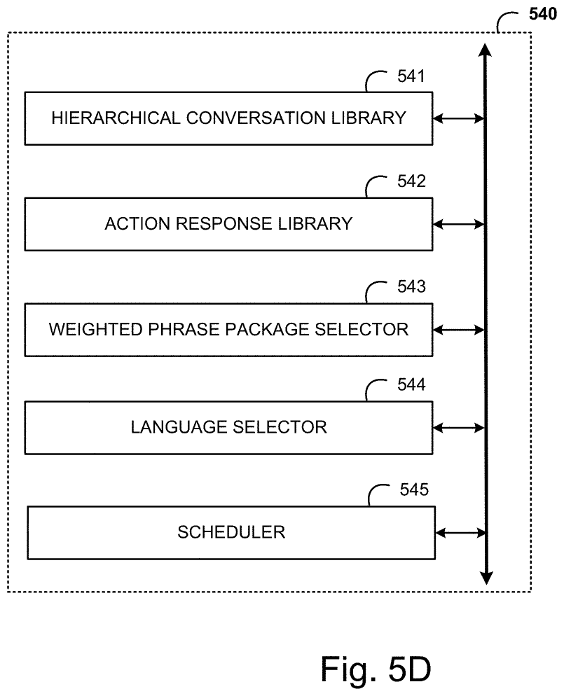

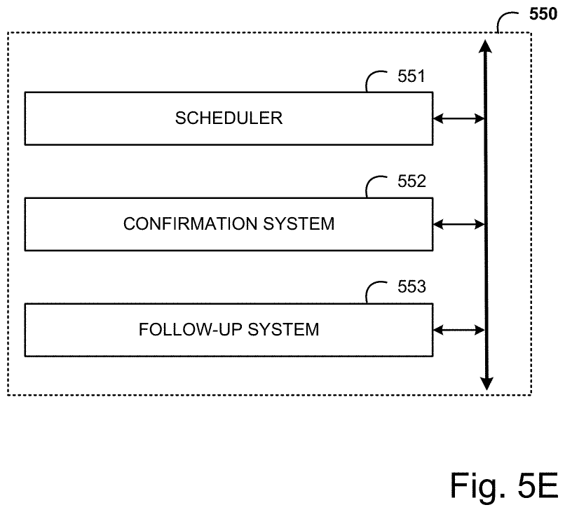

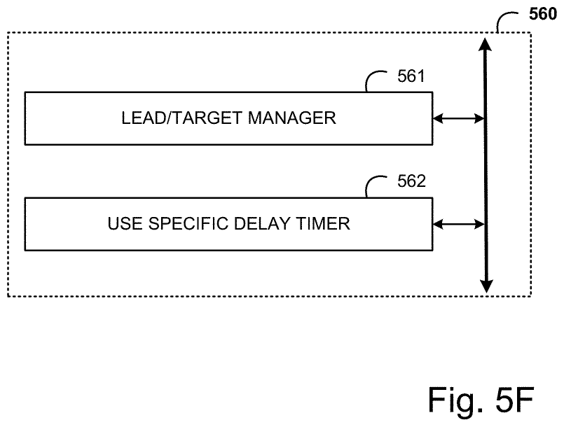

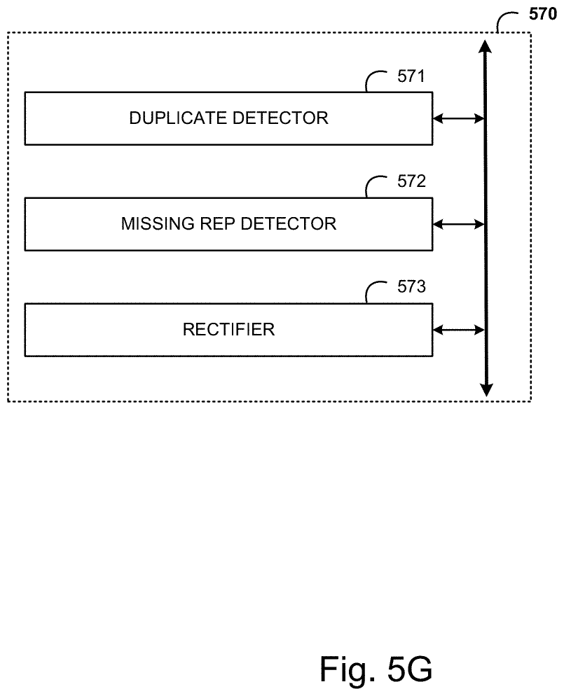

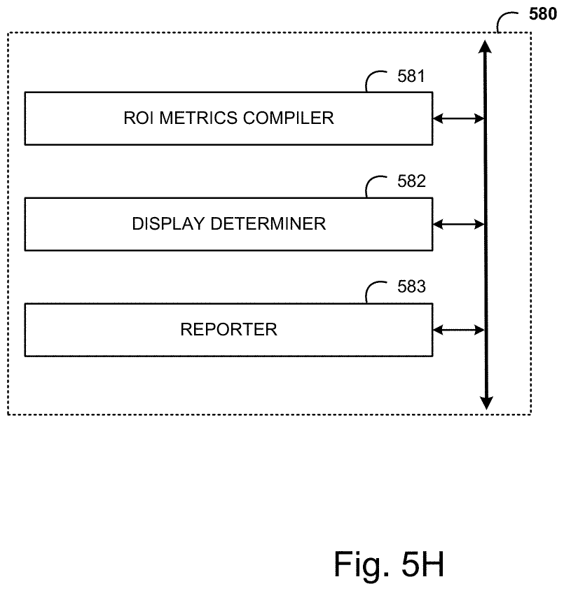

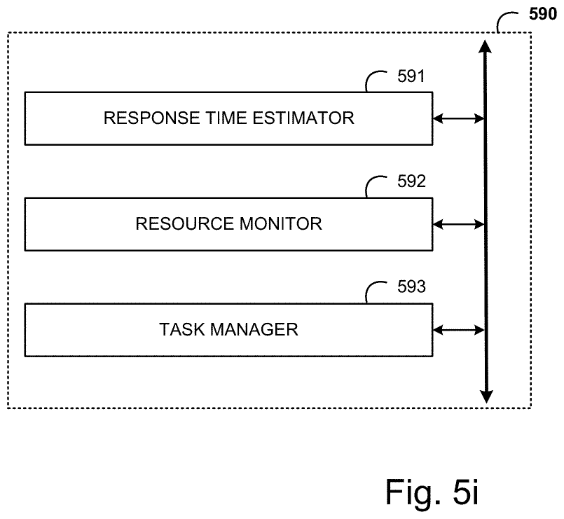

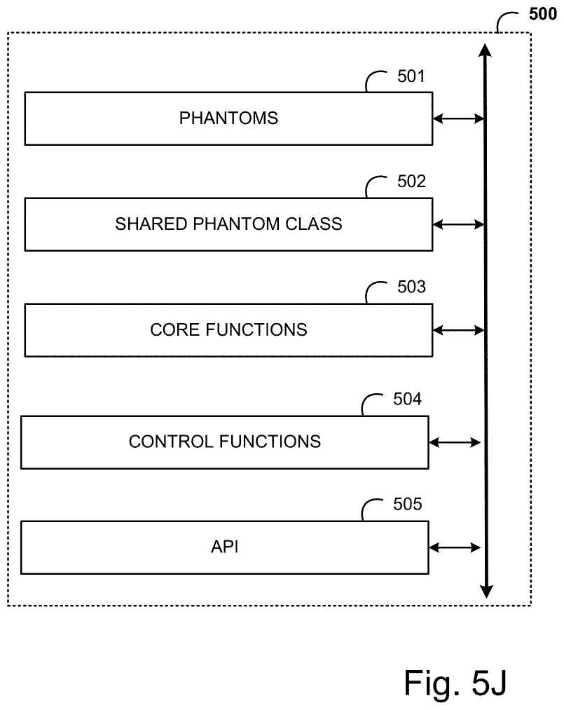

FIG. 5A is an example logical diagram of the message response system 230. In this example system, the contextual knowledge base 440 is utilized in combination with response data 599 received from the person being messaged (the target or recipient). The AI interface 510 receives the response data 599 and provides it to the message receiver 520 for preprocessing. Subsequently, a data processor 530 includes a suite of tools that enable classification of the messages using machine learned models, and based on the classifications generated by the AI and classification tools, target objectives may be updated and the subsequent actions to be taken may be determined. A scheduler and message delivery handler 540 may coordinate the execution of these determined activities, and interface with third party email systems to deliver response messages.

The message delivery handler 540 enables not only the delivery of the generated responses, but also may effectuate the additional actions beyond mere response delivery. The message delivery handler 540 may include phrase selections, contextualizing the response by historical activity, through language selection, and execute additional actions like status updates, appointment setting, and the like.

An appointment setter 550 may set appointments for targets of a conversation with advanced follow-up capabilities. These systems allow for access to other third party calendar and scheduling platforms, and enable entirely autonomous scheduling of appointments from initial target contact all the way through appointment completion.

A specialized service assistant 560 may leverage a number of the same components as the appointment setter 550, but be designed to perform specific use case scheduling. Prototypical examples of a specialized service assistant 550 include any situation where an event triggers an ongoing follow-up activity on a set schedule. For example medical care and car servicing are both areas where such a system particularly excels.

A data fidelity engine 570 performs cleansing of stale data records to ensure that targets are not redundantly contacted by the messaging system, and likewise that the user is accurately represented in the system despite personnel changes or the like. An ROI engine 580 provides analytics and feedback to the client on the value generated by the automated messaging system.

As the systems are required to perform more “real-time” conversation (e.g., chat or audio exchanges), there is an increased need to perform message analysis and response in a very short amount of time. For example, a typical person grows impatient if after three seconds their chat is not responded to. In order to meet these tight timing requirements, processing activities may be optimized by a real-time response accelerator 590.

Many of the aforementioned system components benefit from collecting detailed information from existing external systems within an organization (or more globally). A scraper 500 enables the collection of these data streams to allow these systems to operate more effectively.

Lastly, the continual and high volume conversation exchanges disclosed herein are well suited for maximizing goal achievement through optimization procedures. An A/B tester 515 may be configured to perform binary and multivariate (despite the nomenclature of the component) testing of conversational exchanges to narrow the most effective variables to achieve a given goal.

A/B testing is a powerful tool for making data-driven decisions. At the most basic level, the A/B tester 515 is a tool for analyzing whenever a change is made to the configuration of an AI-driven conversation. If, for example, conversion rates are different before and after a single change, that is a good first indicator of a causal effect of that difference. Every variable is an opportunity for this analysis, down to the names chosen for the virtual assistants. For example, perhaps female names are more effective at sales outreach, but male names are more effective at service outreach. Or possibly names popular in the 1970s are more efficacious than those more popular in the 1990s. These types of hypotheses are easily tested via the A/B tester 515—the data to answer questions like that can best be acquired through multivariate A/B testing (and the simple before/after comparisons described above).

The A/B tester 515 may be automated to test different factors when any change is made, even when multiple variables may change at once. This automated system may test a proposed change in configuration in the real world in such a way that it minimizes the risk of a negative effect and rolls out the change gradually in order to be confident of the positive effect. Consider the example of changing “Hi” to “Hello”—the AI might start by trying the new greeting on a representative sample of 1% of targets, then ramp up to 10% if that seems promising, then completely change over once enough data is collected that we can be confident that the new setting is conclusively performing better.

The A/B tester 515 can also be utilized when the variables are continuous (like price), instead of discrete (like conversation type). In those cases, the A/B tester 515 may use machine learning to intelligently test different points along the continuous axis and optimize the value of that continuous variable—e.g., what if you could tell the minimum percentage discount that was linked with better conversion rate? What if you could get that benefit without having to decide (as a human) anything more than “a discount may be offered in order to increase conversion”? Machine learning enables efficiently zeroing-in on the most effective discount amount (or price, or message timing, etc.) without direct human intervention. This is different in continuous variables because the different options are related in a consistent way, unlike for discrete variables. For example, if a 10% discount is X effective, and a 20% discount is Y effective, there is a reasonable expectation that a 15% discount will be between-X-and-Y effective.

One major benefit derived from the AB tester 515 is that since data is collected from many different clients, the system gets smarter over time as it learns what works from the experiments that the individual customers run. In this way, their domain expertise eventually becomes folded into a larger body of aggregated expertise. Eventually, this shall reach a state where the system itself is the gold standard source of evidence-based expertise about sales conversations. Every client not only gains the benefit of that accumulated expertise (in the form of suggested configuration, or just improved performance that they didn't have to configure), but provides another set of data points to make the system smarter. In a sense, the clients become the “human in the loop” of the machine learning process optimizing these configurations.

The A/B tester 515 may initially be tasked with eliminate or alleviate many of the challenges encountered when studying human behavior, including experimenter bias/inconsistency. Since the conversations are automated, these are essentially already double blind studies and we can be confident that every ‘subject’ received the exact message intended. Sampling can likewise be addressed, as the targets the population of interest and the system has some background information on them, therefore the system can ensure that every group has a comparable and representative sample. Sample size should also not be a problem, since in theory the system has access to the entire population (a given set of targets) that are the subject of the study. Validity may also be addressed, since these experiments are conducted as part of real sales conversations, they are inherently valid (as opposed to a focus group for example, which is not a real world situation). The downside of this is that it does not protect against a change potentially having a negative effect, but by automatically and continuously varying the size of the A/B groups based on confidence level, negative effects can be minimized, as previously discussed. Lastly, Confounding variables may be alleviated, since the system can use statistics not only to control for the variables that are being tracked, but also to identify where there may be an untracked variable having an effect (if there is no statistically significant link between any input/variable and some output/KPI). This is an opportunity for a domain expert to investigate new variables, resulting in a feedback loop—a virtuous cycle where data makes the system smarter, which makes it more effective, which in turn again increases data acquisition, and so forth.

Turning to FIG. 5B, the message receiver 520 is presented in greater detail. The message receiver 520 may include a smart parser 521 which consumes the raw message and splits it into multiple portions, including differentiating between the salutation, reply, close, signature and other message components. This is performed by the search and removal of the outgoing message (in an email this is typically appended below a response message and should mirror the message sent originally to the contact), followed by pre-processing of the test to build features. Subsequently predictions are requested by models for what message segment a particular line of text belongs to, and the response is logically built.

Each line of the raw message is classified on a line-by-line basis by a logical regression model. The model consumer the message ‘features’ that include both words/n-grams and placeholder elements. Examples of placeholder elements include “name present”, “date present” and similar logical variables. The construction of models that consume both n-gram data and placeholder elements has greater accuracy over traditional models in that it is able to generalize for message elements that would normally cause model confusion. For example, a traditional message segment classifier would likely have an error when a current date is encountered unless the model is updated daily and trained on the current date. In contrast, the present placeholder based model will more readily identify this to indicate a header/salutation of the message, whereas a non-present date would be indicative of message body content, for example.

After each line of the message has been classified, the conglomerate of classifications are passed through a series of logical statements to be divided into the categories of “salutation”, “reply”, “close”, “signature” and “other”.

After the smart parser 521 is a language detector 522 which detects the language used in the raw text resulting from the smart parser 521. This language test is run against multiple language models, and the highest scoring model is selected as the model language. A binary confidence level—either ‘confident’ or ‘not confident’ is also output if the model score is above a configured threshold.

After language detection, a tokenizer 523 divides the raw text into individual sentences. The motivation behind this preprocessing is to divide the prospect's response into separate ideas (usually indicated grammatically by sentences) and later predict meanings/intends at the more granular sentence level. This prevents the words/grams/features in one idea from contaminating/creating noise in the prediction of a second idea.

Subsequent to the tokenization, a normalizer 524 generates three new variables for the message. These include a classified text, clean text and the raw text. These different versions are each consumed in later operations. To make the best predictions of intents and meanings in the message, the system should eliminate possible sources of noise. Logic relating to lowercase strings, splitting the text into tokens, looking for entities with special expressions, replacement of these entities with special elements, removal of stop words, removal of intelligens stopwords, and string normalization results in the return of classification text. Once the normalization process is completed a new clean string is generated to be sent to the next step plus other variables that may be stored.

After the raw text has been received and pre-processed in the above manner, the data processor 530 performs the main analysis on the message data. The data processor 530 is provided in greater detail in relation to FIG. 5C. In this component, data is processed to build features for classification text—these are standard text and language features: ngrams, stems and POS tags. The data processor includes an initial function (not illustrated) which, in some embodiments, may utilize a tagger from Stanford API, all included in the lambda function. This data processor function also contains a tagger for each of the supported languages.

The pre-processed response 529 that results from the function is provided next to a critical intent detector 531 which is applied to all incoming message. The critical intent detector's 531 purpose is to find critical (special case) scenarios that occur across the system regardless of client/industry/date/etc. These may include situations like “do not contact”, “out of office” and “spam detection”. The critical intent detector 531 is flexible to allow any intent to be designated as critical by adding it to a table in a relational database where the intent is declared with the name.

A determination of any critical intent being present being negative (“false”), results in the response processing forwarded to a model query engine 532 for additional analysis. If a critical intent is detected, the system would rather immediately provide the response to the entity extractor 536 for entity extraction and output 538 generation.

Entities may include people, objects, locations, phone numbers, email addresses, dates, businesses and the like. Intents, on the other hand, are coded based upon business needs, or may be identified automatically through training or through interaction with a training desk. Particular intents of interest for a business conversation could include, for example, satisfied, disqualified, no further action and further action, in some embodiments. These intents may correspond to situations where the goals for a conversation target have been met (satisfied intent), where such goals are unable to be met (disqualified), where the goal is in progress without need for additional messaging (no further action), and where the goal is in process but requires additional information or messaging to be fully resolved (further action).

The model query engine 532 pulls all models declared in a table for the response situation (industry, client, campaign, etc.). The model query engine 532 executes checks to ensure that it is utilizing the most current version of a query function which has a viable endpoint. This function returns a list of models with their ID and their label translation (from binary to meaning).

Subsequently, the system includes a parallel predictor 533 which elicits predictions from all models available. The parallel predictor 533 returns a list of the highest scoring predictions across all the sentences, with their labels mapped to the meanings. For example, if a message contains three sentences and the predictions for the meaning is “call by phone” for sentence 1 is a 0.23 probability, sentence 2 is a 0.18 probability, and for sentence 3 a 0.93 probability, then the prediction score for the meaning “call by phone” will be 0.93 (e.g., the maximum of the multiple scores).

After parallel prediction the system processes the outputs in a hard code rule engine 534. The hard code rule engine 534 analyzes the text with a set of hard-coded rules. The purpose of this analysis is to prevent trivial errors from happening. If the function does identify a meaning within the text it will remove that model as to not waste time predicting meanings for which there is already an answer and place the prediction (with a score of 1) within the “prediction” section of the event.

Following the hard code rule engine 534 is a prediction filter and sorter 535 which sorts the predictions based upon confidence scores/levels (placing the highest confidences on the top), and filters out predictions where “none” is indicated (the intent is not predicted in the message). This sorting and filtering cleans the prediction dataset, and the information may be stored, along with attendant meanings and their corresponding scores.

After filtering and sorting, entity extraction is performed by the entity extractor 536. As noted previously, if a critical intent was found earlier, the system also immediately would forward to the entity extractor 536 as well. Examples of entities that may be extracted from the raw text could include product brands, product models, emails, phone numbers, Urls, cities, countries, districts, and the like.

Lastly, after entity extraction, analysis is performed by a meaning mapper 537 to generate an output 538 of the data processor 530. The meaning mapper 537 maps the intents identified in the conversation to meanings. The mapping is between all the predictions available in the response and the meanings as a list in a relational database table. Here candidates are created by a system administrator, and these candidates are attached to their scores, if one is higher than another and it is available in the table then it is used to return to the workflow of the prospect. In some embodiments, the meaning mapper 537 also defines which messages are going to manual evaluation or automatic evaluation based on the threshold set for each meaning or intent definition in the relational database.

Turning to FIG. 5D, the message delivery handler 540 is presented in greater detail. The message delivery handler 540 receives output from the data processor 530 and performs its own processing to arrive at the final outgoing message. The message delivery handler 540 may include a hierarchical conversation library 541 for storing all the conversation components for building a coherent message. The hierarchical conversation library 541 may be a large curated library, organized and utilizing multiple inheritance along a number of axes: organizational levels, access-levels (rep->group->customer->public). The hierarchical conversation library 541 leverages sophisticated library management mechanisms, involving a rating system based on achievement of specific conversation objectives, gamification via contribution rewards, and easy searching of conversation libraries based on a clear taxonomy of conversations and conversation trees.

In addition to merely responding to a message with a response, the message delivery handler 540 may also include a set of actions that may be undertaken linked to specific triggers, these actions and associations to triggering events may be stored in an action response library 542. For example, a trigger may include “Please send me the brochure.” This trigger may be linked to the action of attaching a brochure document to the response message, which may be actionable via a webhook or the like. The system may choose attachment materials from a defined library (SalesForce repository, etc.), driven by insights gained from parsing and classifying the previous response, or other knowledge obtained about the target, client, and conversation. Other actions could include initiating a purchase (order a pizza for delivery for example) or pre-starting an ancillary process with data known about the target (kick of an application for a car loan, with name, etc. already pre-filled in for example). Another action that is considered is the automated setting and confirmation of appointments.

The message delivery handler 540 may have a weighted phrase package selector 543 that incorporates phrase packages into a generated message based upon their common usage together, or by some other metric. Lastly, the message delivery handler 540 may operate to select which language to communicate using. Rather than perform classifications using full training sets for each language, as is the traditional mechanism, the systems leverage dictionaries for all supported languages, and translations to reduce the needed level of training sets. In such systems, a primary language is selected, and a full training set is used to build a model for the classification using this language. Smaller training sets for the additional languages may be added into the machine learned model. These smaller sets may be less than half the size of a full training set, or even an order of magnitude smaller. When a response is received, it may be translated into all the supported languages, and this concatenation of the response may be processed for classification. The flip side of this analysis is the ability to alter the language in which new messages are generated. For example, if the system detects that a response is in French, the classification of the response may be performed in the above-mentioned manner, and similarly any additional messaging with this contact may be performed in French.

Determination of which language to use is easiest if the entire exchange is performed in a particular language. The system may default to this language for all future conversation. Likewise, an explicit request to converse in a particular language may be used to determine which language a conversation takes place in. However, when a message is not requesting a preferred language, and has multiple language elements, the system may query the user on a preferred language and conduct all future messaging using the preferred language.

A scheduler 545 used rules for messaging timing and learned behaviors in order to output the message at an appropriate time. For example, when emailing, humans generally have a latency in responding that varies from a few dozen minutes to a day or more. Having a message response sent out too quickly seems artificial. A response exceeding a couple of days, depending upon the context, may cause frustration, irrelevance, or may not be remembered by the other party. As such, the scheduler 545 aims to respond in a more ‘human’ timeframe and is designed to maximize a given conversation objective.

Turning to FIG. 5E details of the appointment setter 550 are provided. The appointment setter 550 also includes a scheduling component 551. However, unlike the scheduler 545 of the delivery handler 540, which is concerned with when to send a response, the appointment scheduler 551 coordinates with the target and one or more internal calendars (or other resource management platforms) to determine when is a viable time for the appointment. This component may engage in a back and forth dialog with the target where dates and times that are available on the calendar(s), and subject to business rules, are proposed and responses countered until an agreeable time is identified for the meeting. The imposed business rules may prevent the scheduler 551 from proposing appointments that are unreasonable. For example, a calendar may be free at midnight, but common sense would suggest that this isn't an acceptable time for a meeting. As such, the rules may include prohibited days and hours, buffer requirements between meetings, and maximum meeting numbers for a set time period. For example, a user of this system may wish to limit the total number of meetings on Mondays to an extent in order to ensure there is sufficient time to adequately prepare for the meetings. Another user may have a requirement that only one meeting is scheduled on Friday afternoons in order to maintain a work-life balance. Additionally, feedback from the target may cause on-the-fly rule generation. For example, if the scheduler 551 proposed a meeting at 8:00 am on Tuesday, and the target responds by stating “Sorry, I drop off the kids then” the system may generate a target specific rule that states that the target is unavailable at 8:00 am on all weekdays. This avoids the cumbersome and annoying situation where the system proposes another meeting for 8:00 am to this target on Wednesday, as it has been indicated already that this time period interferes with a recurrent event.

After the scheduler 551 determines a day and time that is suitable for the target and the user of the system, a confirmation system 552 engages with the target, the user directly, and the user's calendar system to ensure that the time is accurately reflected in the calendar (or other resource management platform), and also to ensure that the target and user are adequately reminded of the appointment. Humans are fallible, and our memory is frequently imperfect. An appointment, even if discussed with the messaging system and the time is decided through negotiation, may be easily forgotten by the target. The user, on the other hand, isn't even involved in the appointment setting process, and unless informed of the event may not realize they have an obligation. The confirmation system 552 thus, in addition to updating the calendar, sends out periodic notifications to both the target and the user via any number of channels. For example, a one day advanced notice email may be sent to the target in some embodiment, a digest email may be sent to the user the morning of the meeting, and half hour reminder text messages may be provided to both the user and target to ensure the parties are prepared for the appointment. Of course the channel of messaging, frequency and timing may all be configured by the user.

Lastly, a follow-up system 553 may engage after the date of the appointment to ensure the meeting actually occurred. When available, CRM notes or other already generated business documents may be used to determine if the meeting actually occurred. Alternatively, the user could be contacted after the set appointment time with a feedback request on if the meeting occurred, and in some cases, if there is any specific follow-up activity required.

When the meeting did occur, the follow-up system 553 may contact the user with tasks that still are required, provide the target a follow-up message (a generic ‘thank you’ message for example), and any tasks that may be required and automated. Particularly, the follow-up system 553 may, in some situation, engage with the specialized service assistant 560 to schedule subsequent tasks, as will be discussed in greater detail below.

If however, the follow-up system 553 is informed that the meeting did not occur as expected, the system may re-engage with the target in order to attempt to reschedule the meeting. The user may be able to interrupt this rescheduling process if the meeting was missed for a systemic reason that would make a meeting undesirable.

Turning now to FIG. 5F, the specialized service assistant 560 is provided in greater detail. The specialized service assistant 560 manages listings of targets and a state of the target using a target manager 561. For example, targets involved with a car dealership may be determined to be prospective customers (actively engaged in a conversation exchange) or current customers (ones who have purchased a vehicle or are in lease). These two groupings may be further refined, for example a current customer may be assigned a purchase date of a new vehicle, whereas a customer of a used vehicle may be tracked by purchase date, vehicle year or mileage.

Tracking targets in this manner is required to properly set delay timers 562, as these delays are use specific. Returning to the car dealership example, a target who has purchased a new vehicle may be contacted at certain times for service activities to maintain warranty. In contrast, a used vehicle customer may also be contacted but for other types of services, as well as for upgrading their vehicle after a certain mileage or model age has been reached.

Continuing to FIG. 5G the data fidelity engine 570 is provided in greater detail. Any machine operated system is only as good as the data driving it. The data fidelity engine 570 ensures that accurate data is being utilized by the messaging system 108. The data fidelity engine 570 is concerned with two main types of data: 1) the duplication of target records, and 2) a complete record of representatives/users of the system in the organization. The data fidelity engine 570 includes a duplicate detector 571 that identifies records of targets that are duplicates. These may include exact duplicates (identical names, email addresses, mailing addresses and the like), or may include fuzzy comparators of the target data. For example two records may include aliases but not directly identical names. Common nicknames may indicate a “same” name, such as John rather than Jonathan. Frequency of name within a population may also be leveraged to determine if two records are duplicates. For example a first record for P. J. Smith and a second record for Paul Smith may be determined to not be duplicates, however P. J. Rickenbaumer and Paul Rickenbaumer would be identified as duplicates due to the probability of other people with a first initial of “P” and the last name of “Smith” versus “Rickenbaumer”. Similarly, matching social security numbers, driver license identification numbers, payment data and email addresses may also be very strong indicators of a duplicate record, even if the name records are not identical.

In a similar vein, a missing representative detector 572 may periodically sweep an organizations' records to determine if new representatives have been hired, or have since left an organization. This system component, when able to access human resources systems (such as payroll data) may be automated to regularly and accurately update representatives.

The rectifier 573 updates the system to remove duplicate targets from conversations that are incompatible with one another, and ensure that only valid representatives are used in appointment setting and as a backend contact for the targets.

Moving on, in FIG. 5H a ROI engine 580 is provided in greater detail. A number of metrics are collected by a metrics compiler 581 that are useful in determining the value generated by the system overall. These metrics included basic activities like number of messages sent or number of appointment scheduled. More valuable metrics could include determinations of particular goals achieved (e.g., sales completed, accounts opened, etc.).

The purpose of the ROI engine 580 is to provide a user a snapshot of how effective the messaging system is, but importantly it is also a promotional tool to convince skeptical users of the value of the messaging system. For this reason, it may be desirable to not provide all the collected ROI metrics to the user, but rather select from the collected data only information that best exemplifies the system's benefits. A display determiner 582 may make these decisions regarding what metrics to display. At a minimum the metrics are first compared against display thresholds. A new system that has recently been deployed and has only set up ten appointments isn't particularly impressive. It may be desirable instead to wait for additional accomplishments before displaying any data. In one example the threshold may be forty appointments set, one hundred response messages sent, and at least ten other goals accomplished before any of these metrics are displayed. Additionally, when a large number of metrics have been collected above the thresholds, the determiner 582 may still order the metrics by multiplying the number of the metric by a weight, and only displaying the highest calculated metrics. For example, if the system is configured to only display the top two ROI metrics, and it has been determined that the system has completed 250 responses, set 100 appointments and completed 70 sales. The system may be configured to provide weights of 1, 3, and 10, respectively. So the scores of these metrics would be 250, 300 and 700 respectively. Thus, for the purposes of this limited example, the ROI metrics selected for display would be the number of sales completed and the number of appointments set, even though the largest activity (by a significant margin) has been responses sent. Ultimately, the ROI metrics selected for display are compiled for display by a reporter 583.

Turning to FIG. 5i, a Real-time response accelerator 590 is provided in greater detail. As noted before, response scheduling should appear ‘human-like’ and be designed to be effective in achieving objectives. For email messaging, this response speed involves delaying the response an acceptable period, because response processing is relatively fast. However, as the communication medium changes this dynamic is no longer necessarily true. For example, if acting in real time audio or video exchange, or even when in a real-time chat exchange, the time between exchanges is very short. In a typical dialog exchange, a delay of 300-800 milliseconds is expected and well tolerated. However, after this 800 millisecond delay a speaker grows uncomfortable and will ‘fill the silence’ with a question or otherwise assume that something is wrong (e.g., bad connection, dropped call etc.). It should be noted that this tolerated speaking delay is culturally dependent, and the provided 300-800 milliseconds is common for American cultures. However, even in cultures that expect longer delays between speakers (such as the Japanese), the acceptable delay is under a couple of seconds at most. Even in chat situations, there is an expectation that the other party will respond rapidly; on the order of three seconds.

Processing a message and generating an appropriate response is a computationally intensive process, especially when performed at volume and scale. As such, in order to meet these strict time requirements, it is necessary to implement specialized processes and systems to ensure response acceleration. The backbone of this system is predicting the time required to perform the analysis of the incoming message, and the time needed to formulate the outgoing response. A response time estimator 591 performs this timing prediction using the available system resources, the size and complexity of the incoming message, and the other message processing workloads. Based upon these estimates a resource monitor 592 can determine which processing assets are needed to complete the response generation in acceptable timeframes, and a task manager 593 can coordinate these assets between the various processing tasks to ensure that the ‘best’ outcome is achieved. Obviously, the best outcome is that all responses are generated within the aforementioned time constraints. However, this may not always be possible, in which case certain tasks may need to be prioritized based upon sensitivity. For example if the system is servicing 5 real-time audio exchanges, 10 chat exchanges and 25 email exchanges, it may be possible to respond to each message in the order it is received on a 5 second average response time. Obviously this is less than ideal. Instead the system may prioritize the audio exchanges with a 1 second maximum delay threshold, 8 of the ten chat exchanges with a three second delay, the remaining two chat exchanges with a 5 second delay, and the email exchanges will be processed at a later time when additional processing resources are available.

Moving on, FIG. 5J provides greater detail of the scraper 500. As noted previously, the present messaging system is extremely valuable within an organizational setting, such as a business, government, or institution. These organizations (and indeed even individuals) rely upon a myriad of computer applications and systems for their operations. In particular customer relationship management (CRM) applications, calendar/resource management software, inventory management software, and email/communication systems are all generally employed. In order to more effectively generate relevant and accurate messages, it is important that relevant information form these other systems is collected. Unfortunately, many of these third party systems do not have easily accessed data outputs. The scraper 500 uses phantoms 501 which are scripts that crawl the third party systems to collect desired data. There are specific phantoms 501 for each third party system which are children of a shared phantom class 502. The shared phantom class 502 is the logic behind the phantom 501 operation, and interacts with the other backend systems. Core functions 503 are a class of functions which communicate with the phantoms and direct them through the flow designated by the shared phantom class. In contrast, control functions 504 set up the entire phantom run by defining global variables, setting time limits for the phantoms and instantiating the various core functions. Lastly an API 505 is an endpoint that allows the phantoms to communicate with the databases of the messaging system.

### II. Methods

Now that the systems for dynamic messaging and natural language processing techniques have been broadly described, attention will be turned to processes employed to perform AI driven conversations with attendant actions and enhanced functionalities.

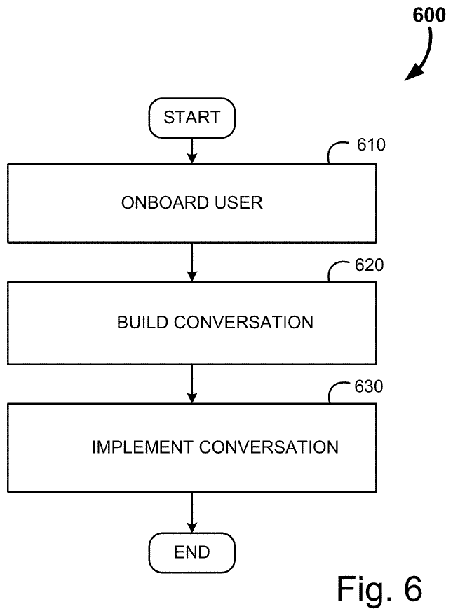

In FIG. 6 an example flow diagram for a dynamic message conversation is provided, shown generally at 600. The process can be broadly broken down into three portions: the on-boarding of a user (at 610), conversation generation (at 620) and conversation implementation (at 630). The following figures and associated disclosure will delve deeper into the specifics of these given process steps.

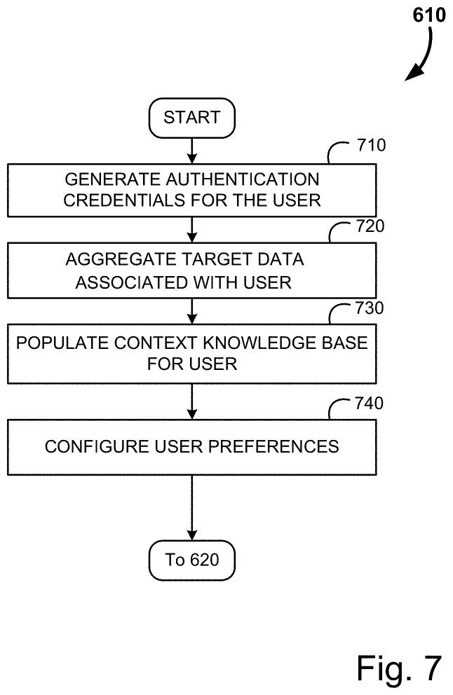

FIG. 7, for example, provides a more detailed look into the on-boarding process, shown generally at 610. Initially a user is provided (or generates) a set of authentication credentials (at 710). This enables subsequent authentication of the user by any known methods of authentication. This may include username and password combinations, biometric identification, device credentials, etc.

Next, the target data associated with the user is imported, or otherwise aggregated, to provide the system with a target database for message generation (at 720). Likewise, context knowledge data may be populated as it pertains to the user (at 730). Often there are general knowledge data sets that can be automatically associated with a new user; however, it is sometimes desirable to have knowledge sets that are unique to the user's conversation that wouldn't be commonly applied. These more specialized knowledge sets may be imported or added by the user directly.

Lastly, the user is able to configure their preferences and settings (at 740). This may be as simple as selecting dashboard layouts, to configuring confidence thresholds required before alerting the user for manual intervention.

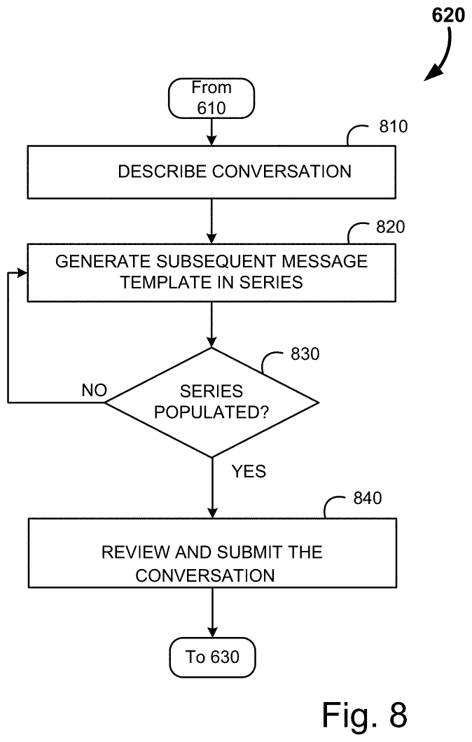

Moving on, FIG. 8 is the example flow diagram for the process of building a conversation, shown generally at 620. The user initiates the new conversation by first describing it (at 810). Conversation description includes providing a conversation name, description, industry selection, and service type. The industry selection and service type may be utilized to ensure the proper knowledge sets are relied upon for the analysis of responses.

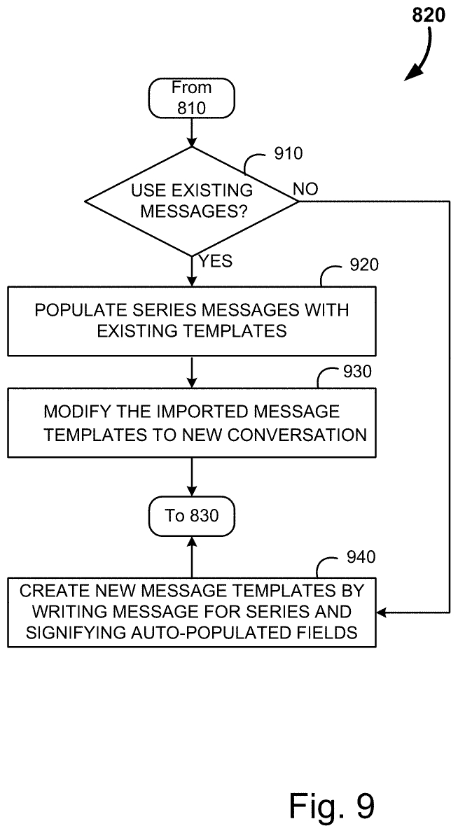

After the conversation is described, the message templates in the conversation are generated (at 820). If the series is populated (at 830), then the conversation is reviewed and submitted (at 840). Otherwise, the next message in the template is generated (at 820). FIG. 9 provides greater details of an example of this sub-process for generating message templates. Initially the user is queried if an existing conversation can be leveraged for templates, or whether a new template is desired (at 910).

If an existing conversation is used, the new message templates are generated by populating the templates with existing templates (at 920). The user is then afforded the opportunity to modify the message templates to better reflect the new conversation (at 930). Since the objectives of many conversations may be similar, the user will tend to generate a library of conversations and conversation fragments that may be reused, with or without modification, in some situations. Reusing conversations has time saving advantages, when it is possible.

However, if there is no suitable conversation to be leveraged, the user may opt to write the message templates from scratch using the Conversation Editor (at 940). When a message template is generated, the bulk of the message is written by the user, and variables are imported for regions of the message that will vary based upon the target data. Successful messages are designed to elicit responses that are readily classified. Higher classification accuracy enables the system to operate longer without user interference, which increases conversation efficiency and user workload.

Messaging conversations can be broken down into individual objectives for each target. Designing conversation objectives allows for a smoother transition between messaging series. Table 1 provides an example set of messaging objectives for a sales conversation.

TABLE 1
Template Objectives

| Series | Objective |
|---|---|
| 1 | Verify Email Address |
| 2 | Obtain Phone Number |
| 2 | Introduce Sales Representative |
| 3 | Verify Rep Follow-Up |

Likewise, conversations can have other arbitrary set of objectives as dictated by client preference, business function, business vertical, channel of communication and language. Objective definition can track the state of every target. Inserting personalized objectives allows immediate question answering at any point in the lifecycle of a target. The state of the conversation objectives can be tracked individually as shown below in reference to Table 2.

TABLE 2
Objective tracking

| Target | Conversa- | | | | |
|---|---|---|---|---|---|
| ID | tion ID | Objective | Type | Pending | Complete |
| 100 | 1 | Verify Email Address | Q | 1 | 1 |
| 100 | 1 | Obtain Phone Number | Q | 0 | 1 |
| 100 | 1 | Give Location Details | I | 1 | 0 |
| 100 | 1 | Verify Rep Follow-Up | Q | 0 | 0 |

Table 2 displays the state of an individual target assigned to conversation 1, as an example. With this design, the state of individual objectives depends on messages sent and responses received. Objectives can be used with an informational template to make a series transition seamless. Tracking a target's objective completion allows for improved definition of target's state, and alternative approaches to conversation message building. Conversation objectives are not immediately required for dynamic message building implementation but become beneficial soon after the start of a conversation to assist in determining when to move forward in a series.

Dynamic message building design depends on ‘message building’ rules in order to compose an outbound document. A Rules child class is built to gather applicable phrase components for an outbound message. Applicable phrases depend on target variables and target state.

To recap, to build a message, possible phrases are gathered for each template component in a template iteration. In some embodiment, a single phrase can be chosen randomly from possible phrases for each template component. Alternatively, as noted before, phrases are gathered and ranked by “relevance”. Each phrase can be thought of as a rule with conditions that determine whether or not the rule can apply and an action describing the phrase's content.

Relevance is calculated based on the number of passing conditions that correlate with a target's state. A single phrase is selected from a pool of most relevant phrases for each message component. Chosen phrases are then imploded to obtain an outbound message. Logic can be universal or data specific as desired for individual message components.

Variable replacement can occur on a per phrase basis, or after a message is composed. Post message-building validation can be integrated into a message-building class. All rules interaction will be maintained with a messaging rules model and user interface.

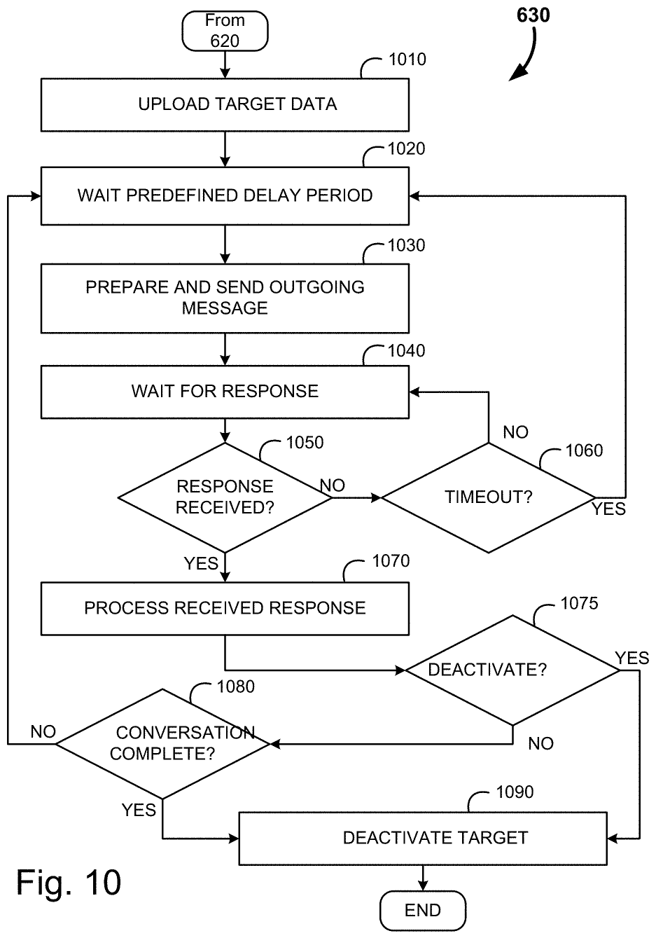

Once the conversation has been built out it is ready for implementation. FIG. 10 is an example flow diagram for the process of implementing the conversation, shown generally at 630. Here the lead (or target) data is uploaded (at 1010). Target data may include any number of data types, but commonly includes names, contact information, date of contact, item the target was interested in (in the context of a sales conversation), etc. Other data can include open comments that targets supplied to the target provider, any items the target may have to trade in, and the date the target came into the target provider's system. Often target data is specific to the industry, and individual users may have unique data that may be employed.

An appropriate delay period is allowed to elapse (at 1020) before the message is prepared and sent out (at 1030). The waiting period is important so that the target does not feel overly pressured, nor the user appears overly eager. Additionally, this delay more accurately mimics a human correspondence (rather than an instantaneous automated message). Additionally, as the system progresses and learns, the delay period may be optimized by a cadence optimizer to be ideally suited for the given message, objective, industry involved, and actor receiving the message.

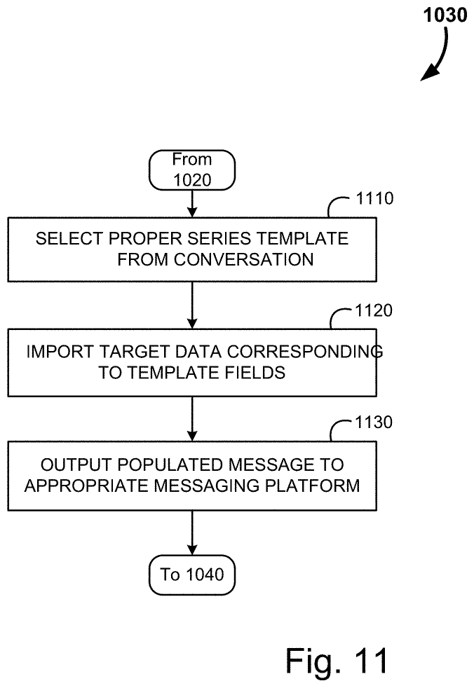

FIG. 11 provides a more detailed example of the message preparation and output. In this example flow diagram, the message within the series is selected based upon which objectives are outstanding (at 1110). Typically, the messages will be presented in a set order; however, if the objective for a particular target has already been met for a given series, then another message may be more appropriate. Likewise, if the recipient didn't respond as expected, or not at all, it may be desirous to have alternate message templates to address the target most effectively.

After the message template is selected from the series, the target data is parsed through, and matches for the variable fields in the message templates are populated (at 1120). Variable filed population, as touched upon earlier, is a complex process that may employ personality matching, and weighting of phrases or other inputs by success rankings. These methods will also be described in greater detail when discussed in relation to variable field population in the context of response generation. Such processes may be equally applicable to this initial population of variable fields.

In addition, or alternate to, personality matching or phrase weighting, selection of wording in a response could, in some embodiments, include matching wording or style of the conversation target. People, in normal conversation, often mirror each other's speech patterns, mannerisms and diction. This is a natural process, and an AI system that similarly incorporates a degree of mimicry results in a more ‘humanlike’ exchange.

Additionally, messaging may be altered by the class of the audience (rather than information related to a specific target personality). For example, the system may address an enterprise customer differently than an individual consumer. Likewise, consumers of one type of good or service may be addressed in subtly different ways than other customers. Likewise, a customer service assistant may have a different tone than an HR assistant, etc.

The populated message is output to the communication channel appropriate messaging platform (at 1130), which as previously discussed typically includes an email service, but may also include SMS services, instant messages, social networks, audio networks using telephony or speakers and microphone, or video communication devices or networks or the like. In some embodiments, the contact receiving the messages may be asked if he has a preferred channel of communication. If so, the channel selected may be utilized for all future communication with the contact. In other embodiments, communication may occur across multiple different communication channels based upon historical efficacy and/or user preference. For example, in some particular situations a contact may indicate a preference for email communication. However, historically, in this example, it has been found that objectives are met more frequently when telephone messages are utilized. In this example, the system may be configured to initially use email messaging with the contact, and only if the contact becomes unresponsive is a phone call utilized to spur the conversation forward. In another embodiment, the system may randomize the channel employed with a given contact, and over time adapt to utilize the channel that is found to be most effective for the given contact.

Returning to FIG. 10, after the message has been output, the process waits for a response (at 1040). If a response is not received (at 1050) the process determines if the wait has been timed out (at 1060). Allowing a target to languish too long may result in missed opportunities; however, pestering the target too frequently may have an adverse impact on the relationship. As such, this timeout period may be user defined and will typically depend on the communication channel. Often the timeout period varies substantially, for example for email communication the timeout period could vary from a few days to a week or more. For real-time chat communication channel implementations, the timeout period could be measured in seconds, and for voice or video communication channel implementations, the timeout could be measured in fractions of a second to seconds. If there has not been a timeout event, then the system continues to wait for a response (at 1050). However, once sufficient time has passed without a response, it may be desirous to return to the delay period (at 1020) and send a follow-up message (at 1030). Often there will be available reminder templates designed for just such a circumstance.

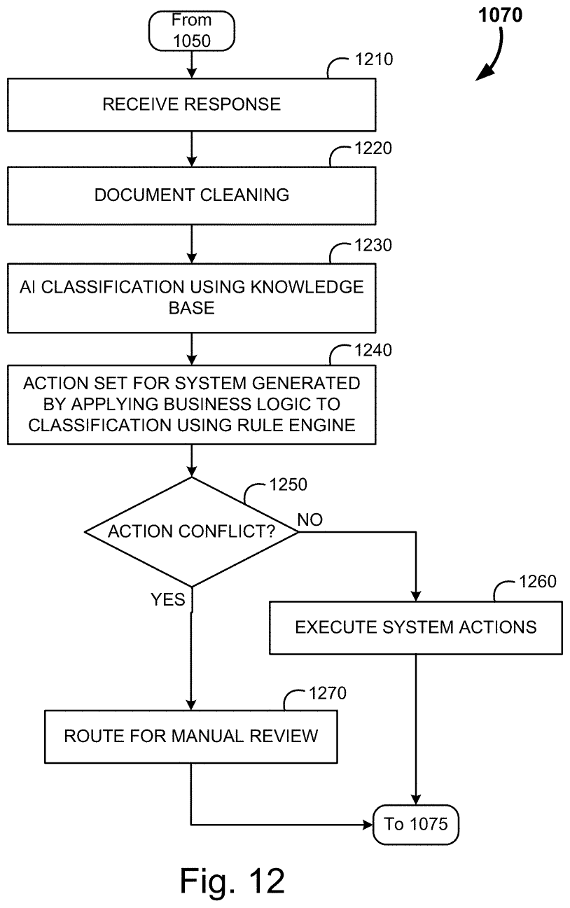

However, if a response is received, the process may continue with the response being processed (at 1070). This processing of the response is described in further detail in relation to FIG. 12. In this sub-process, the response is initially received (at 1210) and the document may be cleaned (at 1220).

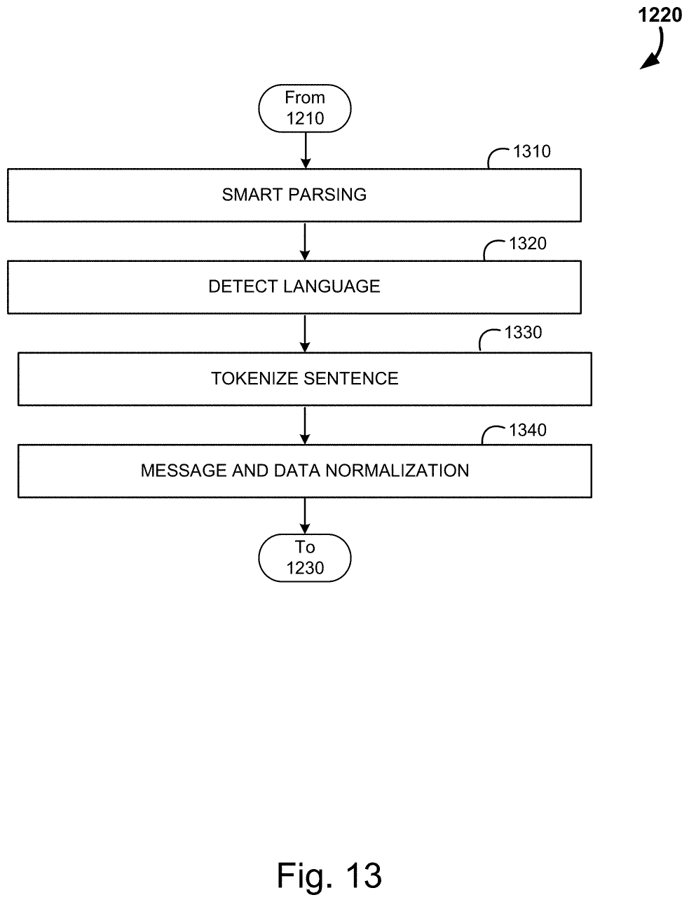

Document cleaning is described in greater detail in relation with FIG. 13. Upon document receipt, adapters may be utilized to extract information from the document for shepherding through the cleaning and classification pipelines. For example, for an email, adapters may exist for the subject and body of the response, often a number of elements need to be removed, including the original message, HTML encoding for HTML style responses, enforce UTF-8 encoding so as to get diacritics and other notation from other languages, and signatures so as to not confuse the AI. An initial step of the document preprocessing/cleaning process is the smart parsing (at 1310) of the document into constituent portions. As discussed previously, this may include breaking the raw text of the message into a salutation, body/reply, close, signature and other category. This process includes the removal of outgoing message components, preprocessing text and build features, as previously discussed, and asking for predictions.

After smart parsing, the system may detect the language (at 1320) of the response using multiple language models and selecting the model with the highest confidence level. Next, the sentences are tokenized (at 1330) which divides the response into separate sentences. This is performed because generally each sentence of a conversation includes a separate/discrete idea or intention. By separating each sentence the risk of token contamination between the sentences is reduced. Only after all this does the normalization process occur (at 1340) where characters and tokens are removed in order to reduce the complexity of the document without changing the intended classification.

After the normalization, documents are further processed through lemmatization, name entity replacement, the creation of n-grams, noun-phrase identification, and extraction of out-of-office features and/or other named entity recognition. Each of these steps may be considered a feature extraction of the document. Historically, extractions have been combined in various ways, which results in an exponential increase in combinations as more features are desired. In response, the present method performs each feature extraction in discrete steps (on an atomic level) and the extractions can be “chained” as desired to extract a specific feature set.

Returning to FIG. 12, after document cleaning, the document is then provided to the AI platform for classification using the knowledge sets/base (at 1230). For the purpose of this disclosure, a “knowledge set” is a corpus of domain specific information that may be leveraged by the machine learned classification model. The knowledge sets may include a plurality of concepts and relationships between these concepts. It may also include basic concept-action pairings. The AI Platform will apply large knowledge sets to classify ‘Continue Messaging’, ‘Do Not Email’ and ‘Send Alert’ insights. Additionally, various domain specific ‘micro-insights’ can use smaller concise knowledge sets to search for distinct elements in responses.

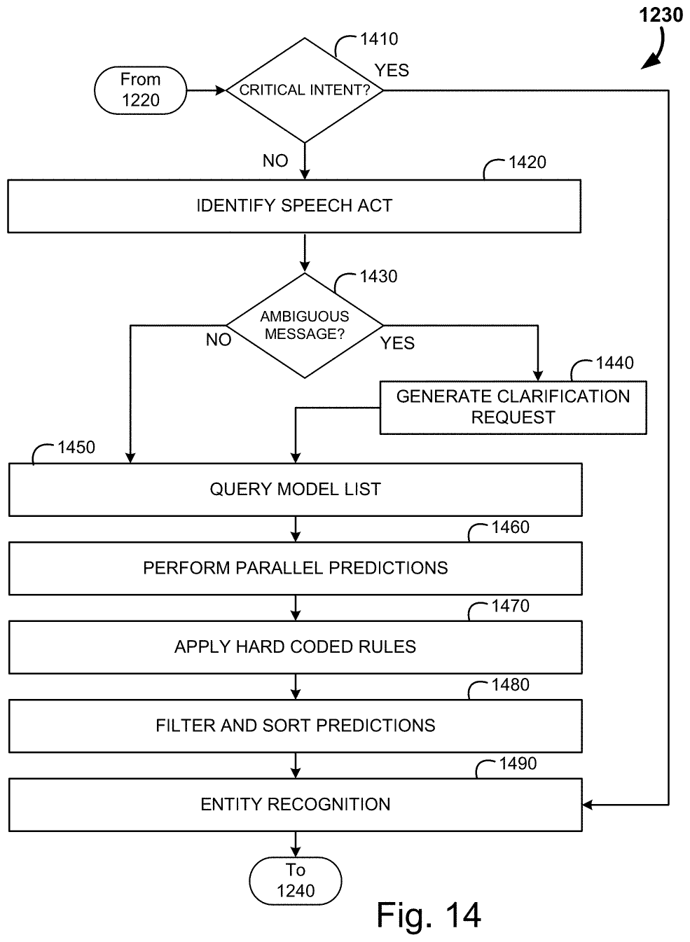

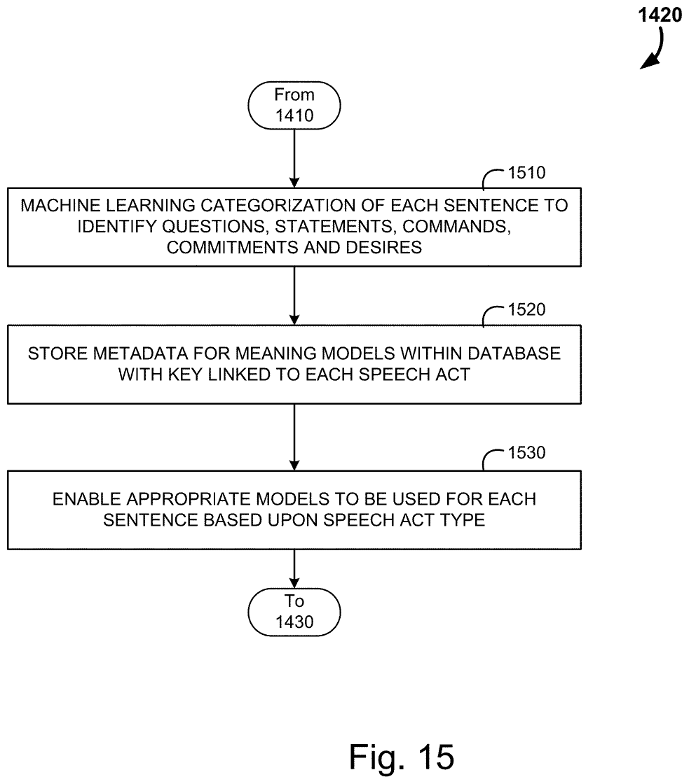

FIG. 14 provides a more detailed view of the classification step 1230. As previously touched upon, this includes an initial detection of possible critical intents (at 1410), which if present causes the process to immediately perform entity extraction (at 1490). However, if no such critical intent is present the next stage is to determine speech acts (at 1420). FIG. 15 provides greater detail into the identification of such speech acts. This sub-process includes performance of machine learning categorization of each sentence to classify it as either a question, statement, command, commitment or desire (at 1510). The identification of these speech acts enables better differentiation between the parallel prediction model results, as some models may perform significantly differently based upon if the sentence is a question versus a desire, for example. For the purposes of this disclosure, a speech act of a command is defined as an utterance that compels someone to perform an action. A question is an utterance that asks for information and/or an opinion. A statement is an utterance that merely conveys information and/or opinions. A desire is an utterance that conveys a desire or need that the agent has. And a commitment is an utterance that expresses a commitment to perform an action by an agent.

Each speech act includes its own feature set and models used for classification of sentences that fall into the given speech acts. The metadata of the meaning models is stored into the database containing a key that links to the correct speech act (at 1520). This generates a hierarchy on a meaning level using a more natural approach to the language, and enables appropriate models to be used for each sentence based upon it's respective speech act (at 1530).

Returning to FIG. 14, after speech act identification an inquiry is made (at 1430) if the message is ambiguous. An ambiguous message is one for which a classification can be rendered at a high level of confidence, but which meaning is still unclear due to lack of contextual cues. Such ambiguous messages may be responded to by generating and sending a clarification request (at 1440).

However, if the message is not ambiguous, or after a clarification has been received, the process may proceed to a query of the model list (at 1450). This function pulls all models declared in a table for that situation (industry, client, campaign and speech act). It executes checks to ensure that it is the most current version and has a viable endpoint. Then the function returns a list of models with their ID and their label translation (from binary to meaning). Once the models have been identified, they may be executed in parallel to perform parallel predictions (at 1460). This component asks for predictions from all models available in the input to all of the “clean text” instances availed. It will return a list of the highest scoring predictions across all the sentences with their labels mapped to the meanings.

Subsequently, hard coded rules may be applied (at 1470) which analyzes the text with a set of hard-coded rules. The purpose is to prevent silly errors from happening. If the function does identify a meaning within the text it will remove that model from the “model-query-list” as to not waste time predicting meanings for which there is already an answer and place the prediction (with a score of 1) within the “prediction” section of the event. Next, the predictions are filtered and sorted (at 1480). Sorting and filtering places highest level predictions on the top of the prediction listing, and removes predictions of ‘none’ from the dataset. This process cleans up the prediction data. The results are then stored, along with the meanings and corresponding scores.

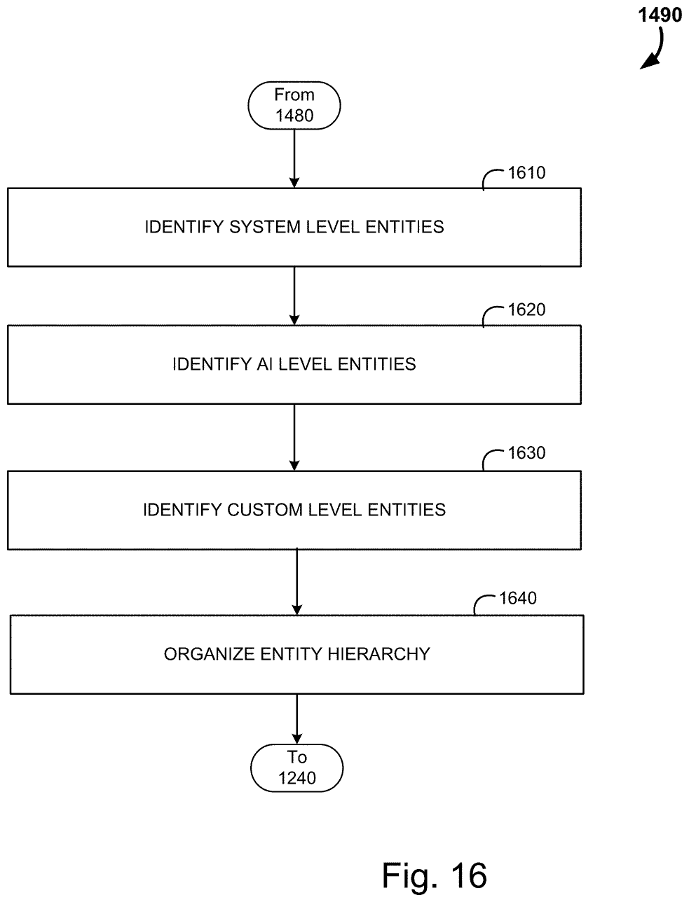

Next, entity recognition is performed (at 1490). A more detailed explanation of this entity recognition process is provided in relation to FIG. 16. Initially, system level entities are identified (at 1610), followed by AI level entities and custom level entities (at steps 1620 and 1630 respectively). The entities are then organized into a hierarchy (at 1640).

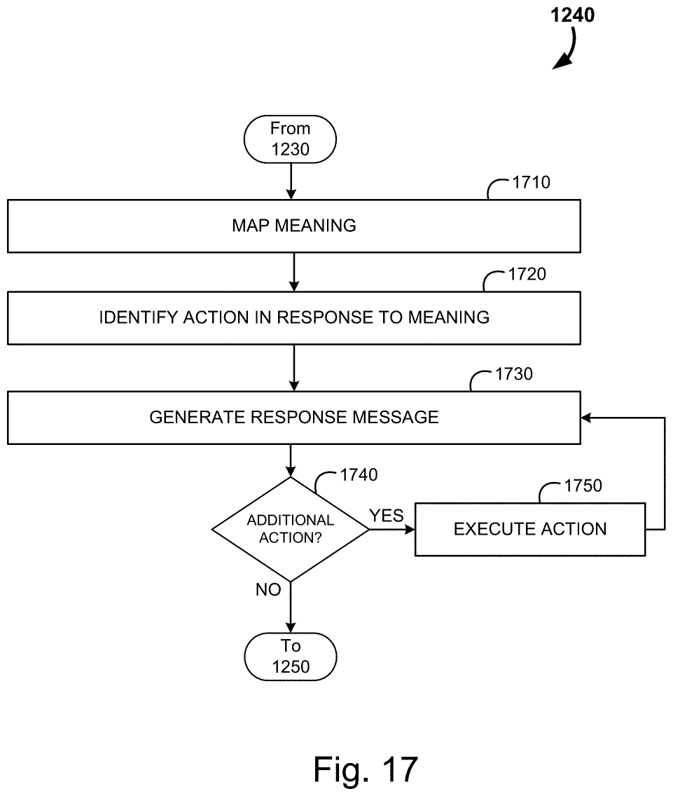

Returning to FIG. 12, after data processing has been performed, actions may be set by application of business logic to the classification (at 1240). This sub process is described in greater detail in relation to FIG. 17. A critical component of action determination is to map the intents predicted during classification to meanings (at 1710). The mapping engine includes a set of rules that are stored in a table at the creation of a conversation. These rules map meanings to intents, and the intents are defined ad hoc by the person who is creating the conversation. The intents may be called as they need to be, or may be restricted to recommendations of ‘intents’ based on previous answers for a given question.

As an extension, a template key for each intent for a given action exists. This allows conversations to send prospects to the same actions but replies to them in a different way for different intents. In this manner actions may be identified that apply in response to the meaning (at 1720). This response is generated (at 1730) by identifying an appropriate response template, and populating the variable fields within the template. Population of the variable fields includes replacement of facts and entity fields from the conversation library based upon an inheritance hierarchy. The conversation library is curated and includes specific rules for inheritance along organization levels and degree of access. This results in the insertion of customer/industry specific values at specific place in the outgoing messages, as well as employing different lexica or jargon for different industries or clients. Wording and structure may also be influenced by defined conversation objectives and/or specific data or properties of the specific target.

Specific phrases may be selected based upon weighted outcomes (success ranks). The system calculates phrase relevance scores to determine the most relevant phrases given a lead state, sending template, and message component. Some (not all) of the attributes used to describe lead state are: the client, the conversation, the objective (primary versus secondary objective), series in the conversation, and attempt number in the series, insights, target language and target variables. For each message component, the builder filters (potentially thousands of) phrases to obtain a set of maximum-relevance candidates. In some embodiments, within this set of maximum-relevance candidates, a single phrase is randomly selected to satisfy a message component. As feedback is collected, phrase selection is impacted by phrase performance over time, as discussed previously. In some embodiments, every phrase selected for an outgoing message is logged. Sent phrases are aggregated into daily windows by Client, Conversation, Series, and Attempt. When a response is received, phrases in the last outgoing message are tagged as ‘engaged’. When a positive response triggers another outgoing message, the previous sent phrases are tagged as ‘continue’. The following metrics are aggregated into daily windows: total sent, total engaged, total continue, engage ratio, and continue ratio.

To impact message-building, phrase performance must be quantified and calculated for each phrase. This may be performed using the following equation:

$$performance = \frac{\begin{matrix}( percent\_enegaged + \\ percent\_continue )\end{matrix}}{2} \qquad Equation 1 \text{:} Phrase performance$$

Engagement and continuation percentages are gathered based on messages sent within the last 90 days, or some other predefined history period. Performance calculations enable performance-driven phrase selection. Relative scores within maximum-relevance phrases can be used to calculate a selection distribution in place of random distribution.

Phrase performance can fluctuate significantly when sending volume is low. To minimize error at low sending volumes, a

$$\frac{ln ( x )}{x}$$

padding window is applied to augment all phrase-performance scores. The padding is effectively zero when total_sent is larger than 1,500 sent messages. This padded performance is performed using the following equation:

$$performance\_pad = 100 \times \frac{ln ( total\_sent + LN\_OFFSET )}{total\_sent + ZERO\_OFFSET} \qquad Equation 2 \text{:} Padded performance$$

Performance scores are augmented with the performance pad prior to calculating distribution weights using the following equation:

performance′=performance+performance_pad Equation 3: Augmented phrase performance

As noted, phrase performance may be calculated based on metrics gathered in the last 90 days. That window can change to alter selection behavior. Weighting of metrics may also be based on time. For example, metrics gathered in the last 30 days may be assigned a different weight than metrics gathered in the last 30-60 days. Weighting metrics based on time may affect selection behaviors as well. Phrases can be shared across client, conversation series, attempt, etc. It should be noted that alternate mechanisms for calculating phrase performance are also possible, such as King of the Hill or Reinforcement Learning, deep learning, etc.

Due to the fact that message attempt is correlated with engagement; metrics are gathered per attempt to avoid introducing engagement bias. Additionally, variable values can impact phrase performance; thus, calculating metrics per client is done to avoid introducing variable value bias.

Adding performance calculations to message building increases the amount of time to build a single message. System improvements are required to offset this additional time requirement. These may include caching performance data to minimize redundant database queries, aggregating performance data into windows larger than one day, and aggregating performance values to minimize calculations made at runtime.

In addition to performance-based selection, as discussed above, phrase selection may be influenced by the “personality” of the system for the given conversation. Personality of an AI assistant may not just be set, as discussed previously, but may likewise be learned using machine learning techniques that determines what personality traits are desirable to achieve a particular goal, or that generally has more favorable results.

Message phrase packages are constructed to be tone, cadence, and timbre consistent throughout, and are tagged with descriptions of these traits (professional, firm, casual, friendly, etc.), using standard methods from cognitive psychology. Additionally, in some embodiments, each phrase may include a matrix of metadata that quantifies the degree a particular phrase applies to each of the traits. The system will then map these traits to the correct set of descriptions of the phrase packages and enable the correct packages. This will allow customers or consultants to more easily get exactly the right Assistant personality (or conversation personality) for their company, particular target, and conversation. This may then be compared to the identity personality profile, and the phrases which are most similar to the personality may be preferentially chosen, in combination with the phrase performance metrics. A random element may additionally be incorporated in some circumstances to add phrase selection variability and/or continued phrase performance measurement accuracy. After phrase selection, the phrases replace the variables in the template. The completed templates are then output as a response (at 1750). The system may determine if additional actions are needed (at 1740), which may include attaching documents, setting calendar appointments, inclusion of web hooks, or similar activities.

Returning all the way back to FIG. 12, after the actions are generated, a determination is made whether there is an action conflict (at 1250). Manual review may be needed when such a conflict exists (at 1270). Otherwise, the actions may be executed by the system (at 1260).

Returning then to FIG. 10, after the response has been processed, a determination is made whether to deactivate the target (at 1075). Such a deactivation may be determined as needed when the target requests it. If so, then the target is deactivated (at 1090). If not, the process continues by determining if the conversation for the given target is complete (at 1080). The conversation may be completed when all objectives for the target have been met, or when there are no longer messages in the series that are applicable to the given target. Once the conversation is completed, the target may likewise be deactivated (at 1090).

However, if the conversation is not yet complete, the process may return to the delay period (at 1020) before preparing and sending out the next message in the series (at 1030). The process iterates in this manner until the target requests deactivation, or until all objectives are met. This concludes the main process for a comprehensive messaging conversation.

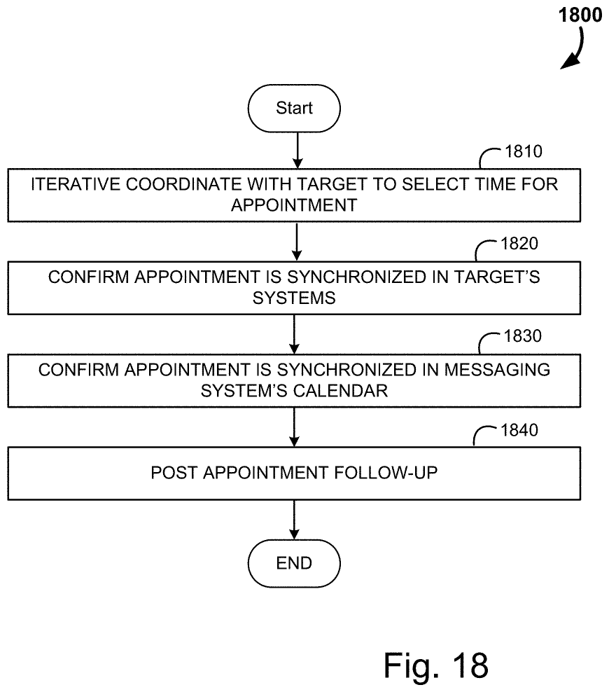

Turning now to FIG. 18, an example process flow diagram is provided for the setting of appointments, shown generally at 1800. In this example process, the target is iteratively engaged to negotiate a time for the appointment that meets the needs of the target, is available on a user's calendar, and meets all scheduling rules that may be present (at 1810). Next the process confirms the appointment with the target via one or more communications and/or direct updating of the target's scheduling systems (at 1820). Likewise, the messaging system's user's calendar is appropriately updated by the appointment setter (at 1830). This may additionally include sending the user additional reminder notifications, in some embodiments. Lastly, the method performs post appointment follow-up (at 1840) including rescheduling any missed appointments, ensuring proper post appointment messages and actions are taken, and the like.

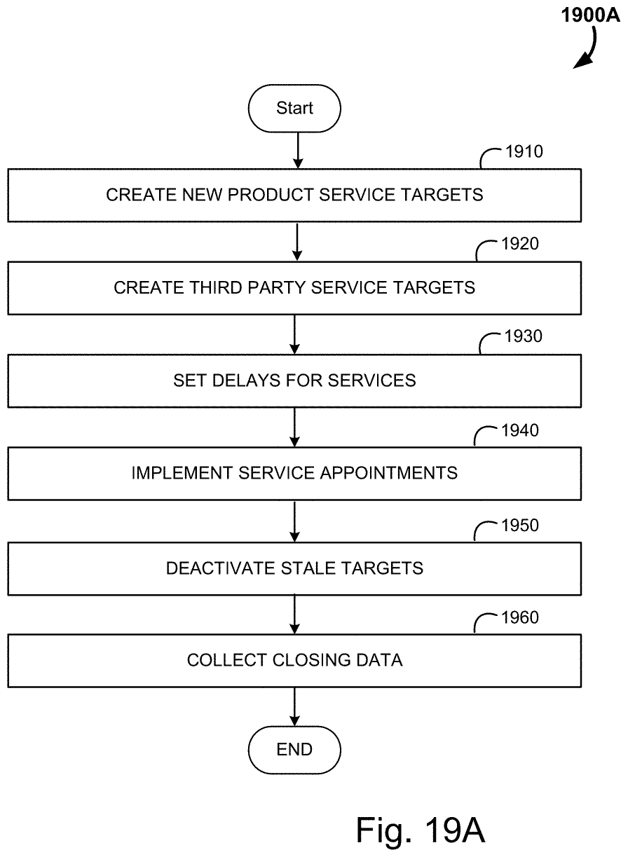

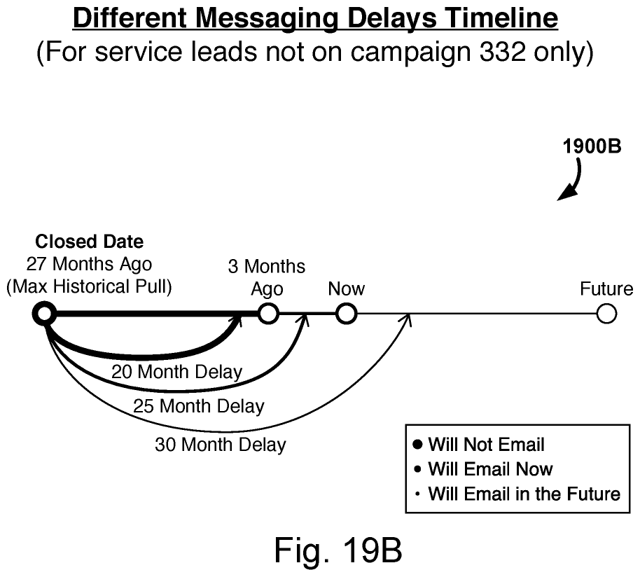

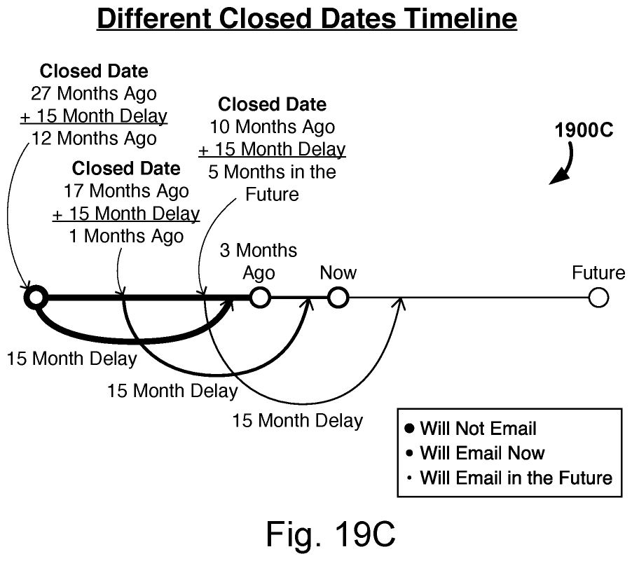

Turning now to FIG. 19A a method for the specialized service activity is provided generally at 1900A. In this example process new product service targets are initially generated (at 1910). Similarly, third party service targets may be generated (at 1920). Use specific delays for these services are set (at 1930) and the aforementioned appointment setting process may be employed (at 1940) to meet these service requirements. When needed, stale targets may be deactivated (at 1950) and closing data from the service is collected (at 1960).

FIG. 19B provides an example illustration 1900B of a first example delay timeline for such service setting associated with an example car sales use case. At the initial time period the vehicle is sold new to the user. After the sale of the vehicle there is a twenty month delay where the system is restricted from emailing the purchaser for any service activity. After the 20 month delay the system is set to initialize with service request communications. A second set of communications is then scheduled for a future date at 30 months post sale.

Similarly, in FIG. 19C another example illustration 1900C for a second example set of delays is provided. This set of delays is based not upon historical data, but rather upon actual closing dates of known sales. In this example, the date the vehicle is purchased is known (as opposed to leveraging old consumer data without exact purchase date information). After a 15 month delay, calculated for each purchaser separately, an initial service communication is sent to each target. Not illustrated, it may be desirable to stage separate additional communication events for other service needs either based upon the date of the purchase or upon the previous service event.

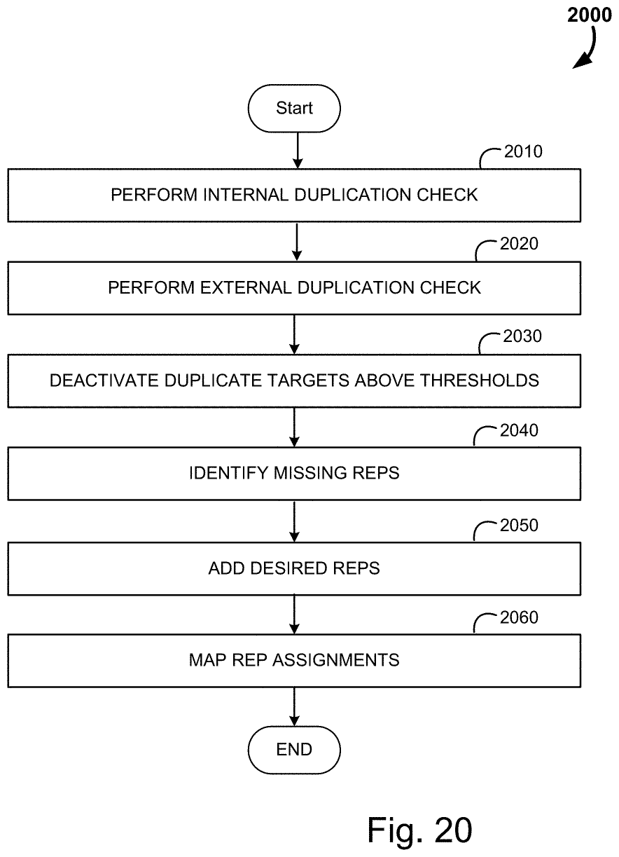

Turning now to FIG. 20, an example flowchart is provided for the data fidelity process, shown generally at 2000. In this process the targets are checked for duplicate records (at 2010) based upon data similarities using exact matches and fuzzy logic approximate matches. External duplicates to the instant conversation may also be identified (at 2020), and when identified a determination made whether there is a conflict between the instant conversation and the source of the duplicate record. For example, returning to the vehicle sales example, a target for a particular car dealership would conflict with a record for another car dealership, as these communications would conflict with one another's goals, and secondly may be sufficiently similar to suggest to the target that the conversations are actually artificial and that they are not speaking with a real human. In contrast, a record for the aforementioned car dealership may be perfectly able to be simultaneously in an artificial conversation with a scheduling assistant for a doctor's office. The goals of these systems are not in conflict, and the context of the discussions are unlikely to expose similarities in the message construction to indicate the messages are being produced by an AI system.

Once the duplicate target records are identified, those above thresholds for confidence of being duplicates (or determined to be in a significant conflict with one another) may be deactivated (at 2030). On the flip side, missing employees/representatives of the user's system are identified (at 2040) using HR feeds, manual input, payroll data and/or circumstantial evidence, such as email exchanges. These identified representatives are then added to the system (at 2050) and assignments between the various representatives and targets may be assessed and remapped accordingly (at 2060) to balance workloads.

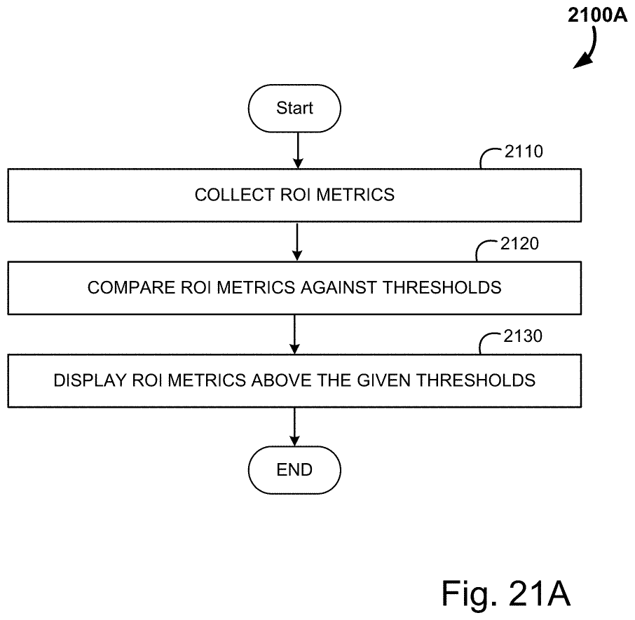

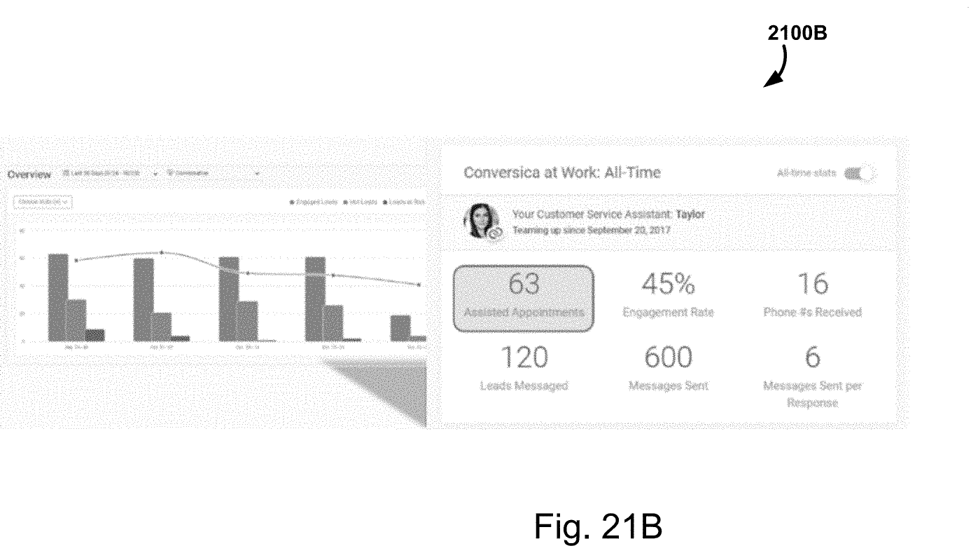

Moving on to FIG. 21A, an example process for ROI analysis is provided generally at 2100A. In this example process, the metrics of interest for showing the system's value to the user are collected (at 2110), and compared against minimum display thresholds (at 2120). Only metrics that are large enough (above the needed thresholds) are eligible for display to the user. When a surplus of ROI metrics are available, the system selects the ‘best’ metrics for display (at 2130), based upon the total quantitative value of the metric and the weighted importance of the activity. For example actions like completing a sale may be significantly more heavily weighted as compared against mere response generation or other more trivial tasks.

FIG. 21B provides an example screenshot of such an ROI dashboard, shown generally at 2100B. In this example, the degree of engaged targets, ‘hot’ targets, and targets at risk of being lost are graphed. Additionally, total numbers of appointments set, number of targets being actively managed, number of response messages sent, engagement rates, contact information received and number of messages sent per response are all tabulated and displayed to the user to illustrate the value the messaging system is providing.

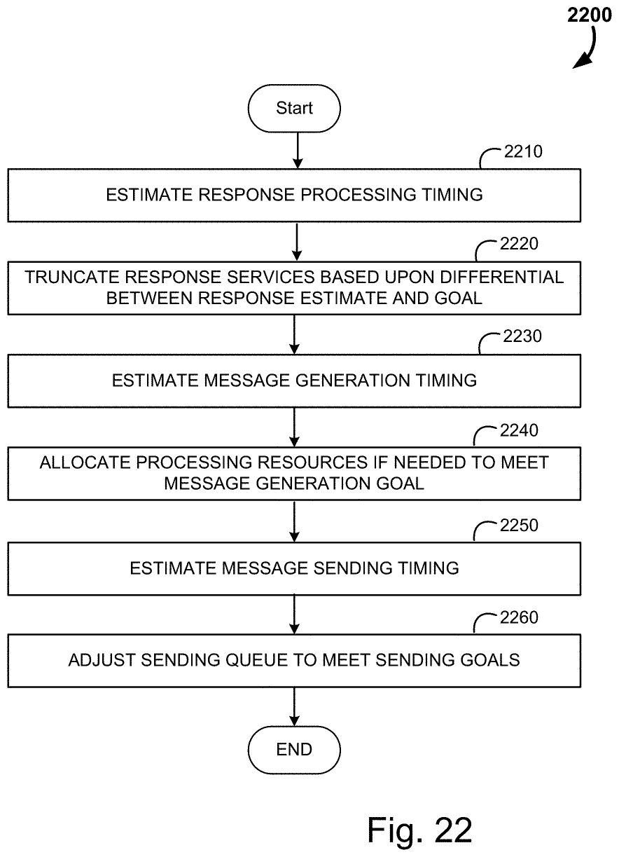

Moving on, FIG. 22 provides an example flow diagram for the process of accelerating response generation necessitated by real-time audio, video or chat conversations, shown generally at 2200. In this example process the response processing time is initially estimated (at 2210) in order to determine which processing aspects may require additional resources, out of queue processing, or truncation of processing in order to meet the requisite time limitations. When the timing goal and the estimate are not in alignment, the initial time saving step is to limit the degree of processing required (at 2220). For example, rather than undergoing a full panel of parallel model classifications, it may be much faster to process the response through a more limited set of classification models. Additionally, rather than undergo complete natural language processing, it may be desirable to estimate certain activities, such as some of the entity replacements, based upon rules rather than full deep learning analysis, for example.

Similarly, the time required to generate a response message is also estimated (at 2230). Historically, response generation is less processing intensive than the analysis of a received message, and as such mere scaling of processing resources is sufficient to meet the timing goals for the generation of a response (at 2240). Similarly, message sending is estimated (at 2250) which is generally much easier to control and manage as compared to initial intent processing and message classification. Sending a message is very fast, and the only reason timing goals may be difficult to obtain is if a very large number of messages are queued for being sent out. Thus to ensure the timing goal for the message sending is met, the process may adjust the order in which messages are delivered (at 2260).

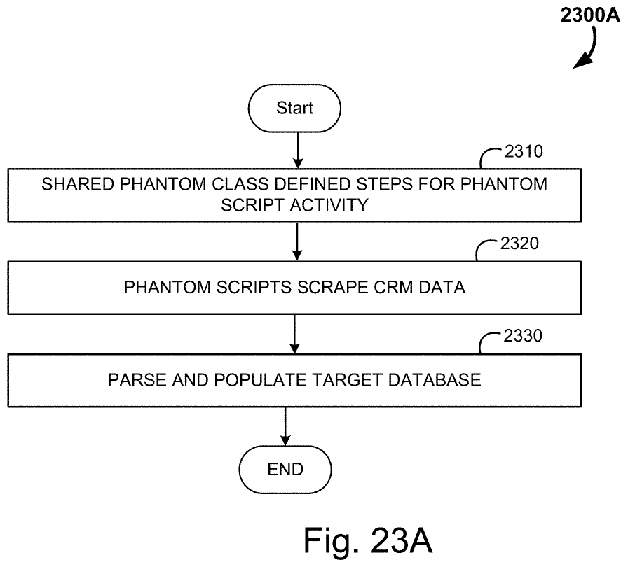

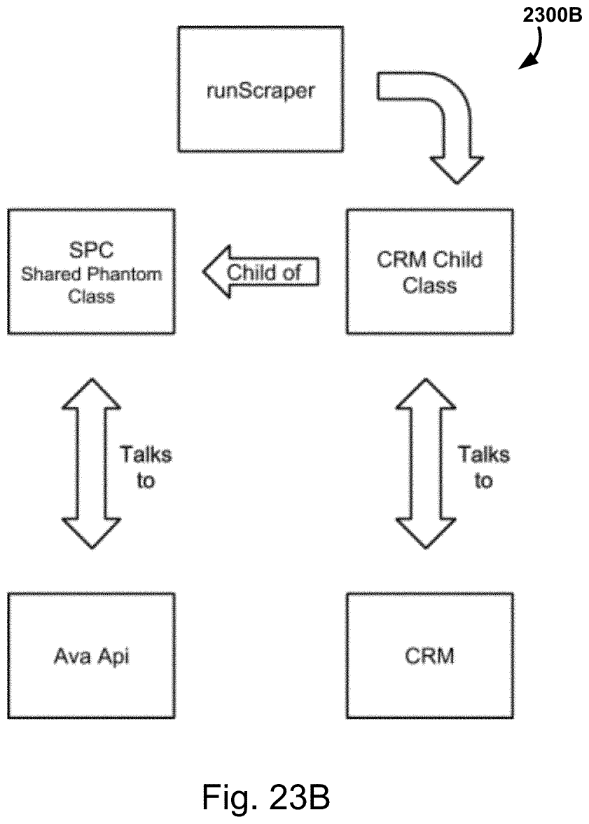

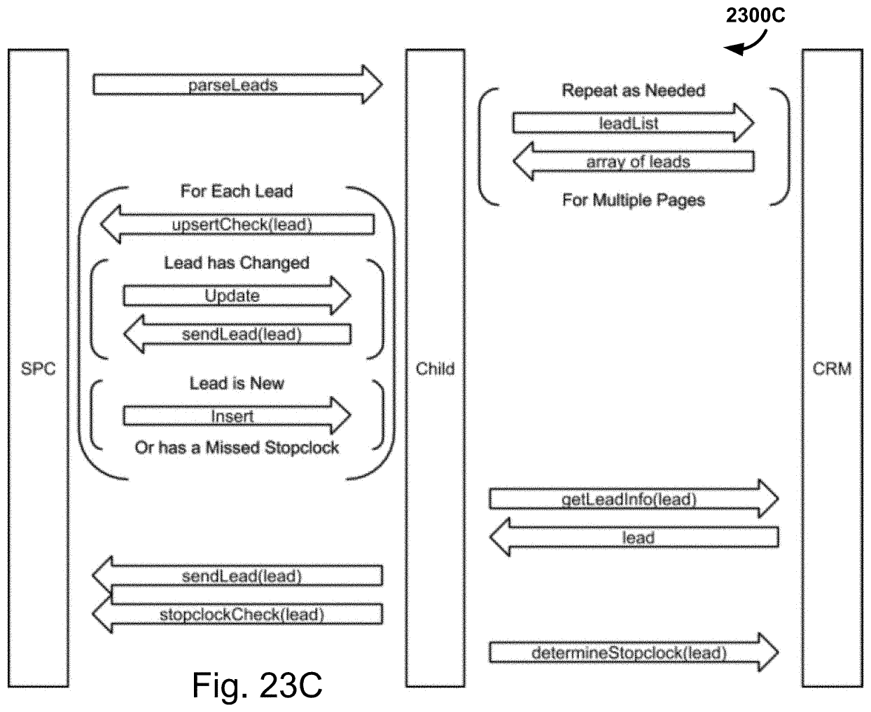

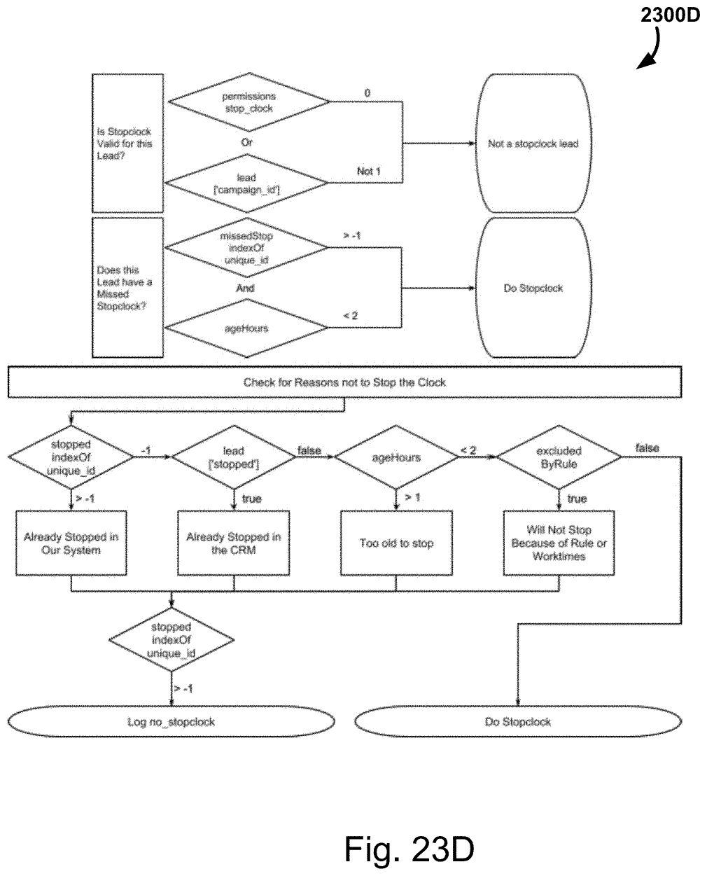

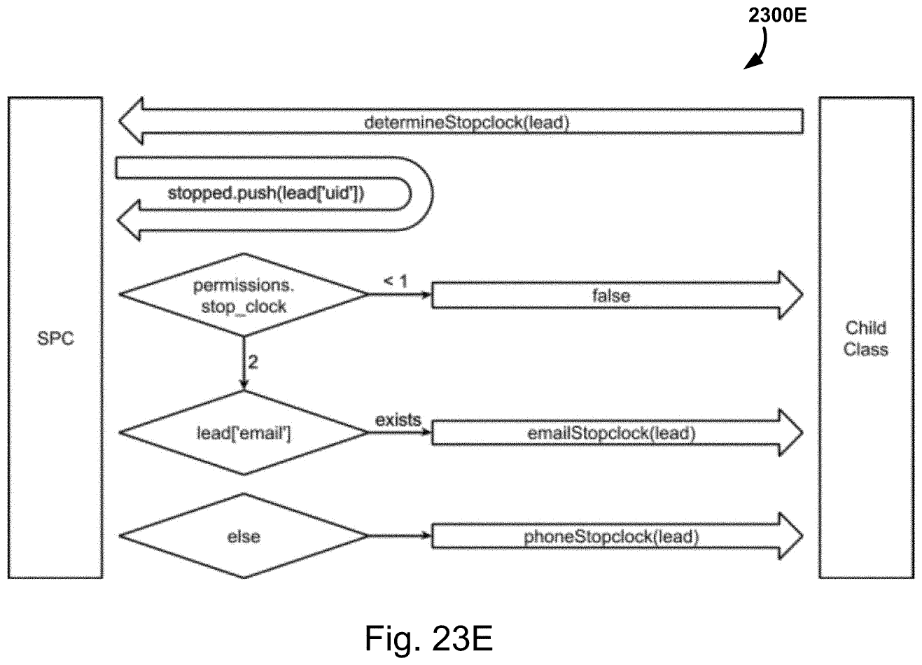

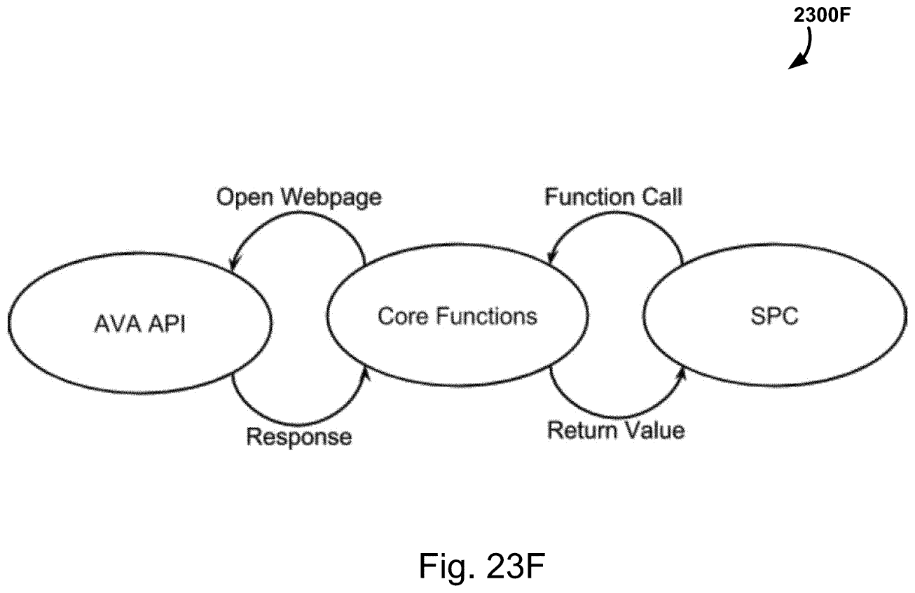

Turning to FIG. 23A, an example process for the scraping of third party systems is provided, as shown generally at 2300A. As previously noted, the shared phantom class defines the steps to be taken by the phantom scripts (at 2310), which then scrape the third party system data (at 2320). Here the third party system is being exemplified as comprising a CRM application. The target database is then parsed and populated with the collected data (at 2330).

FIG. 23B provides a logical diagram of this process, shown generally at 2300B. Again, the scraper scripts are run on the child (phantom class) scripts, which collects data from the CRM system (or other third party system). The shared phantom class directs the child phantoms and interacts with API's in the user's system to populate the user's databases.

Likewise, FIG. 23C provides an illustration of the activity progression between the shared phantom class, the child phantom and the third party system, shown generally at 2300C. The shared phantom class initially parses out the targets and provides this information to the child phantom. Parsing the targets allows each target in the third party system to have information collected for it. A target list in the messaging system may be leveraged to perform this parsing activity. Generally the target list includes a unique ID for the target, a representative mapped to the target, and the target's status. The third party data can be used to check if the representative mapping is still accurate, and if the target's status has been updated.

For each target, the phantom checks the target information and return it to the shared phantom class. The shared phantom class determines if the target is an update, or an insert. If it is an update there is no need to collect additional information, however if the target is new, or requires a stopclock, the shared phantom class determines that more information should be collected for the target; particularly the target's name, contact information and a stopclock (if applicable).

When the first target is inputted into the CRM (or other third party system as applicable) a clock is started. When the representative initially contacts the target the clock may be stopped. This indicates the response time for the organization. If the messaging system is directed at acting on behalf of the representative, the message system may instead contact the target and stop the clock accordingly. This activity is what is referred to as a “stopclock”.

The determination of whether a target requires a stopclock event can be quite difficult, and this logical component is managed exclusively by the shared phantom class. Additionally, the medium of contact used to effectuate the stopclock (e.g., email, text, phone call, etc.) is determined by the shared phantom class logic. A set of customized rules for the user or organization may be applied to assist in the decision of whether a stopclock event is desired, and if so the type to use.

FIG. 23D illustrates this logical decision process, shown generally at 2300D. A question is first posed if a stopclock event is valid for the given target. This can be determined by checking the target ID against an array of already addressed targets. This ensures that a given target is not repeatedly sent a stopclock event (e.g., multiple redundant or unintended messages). Secondly, a determination is made if there is a missed stopclock for the target. If the target is valid for a stopclock, missing a stopclock index, and under two hours of age, then a stopclock event may be initiated. In contrast if the target is not valid, not missing a stop index, or within the two hour limit, then no stopclock is performed. This results if the target is already within the messaging system data, already stopped within the CRM system (or other third party system), too old to be stopped, or subject to worktime rules preventing a stopclock event (e.g., after work hours for example).

FIG. 23E provides an additional illustration of the interactions between the shared phantom class, and the child phantom, shown generally at 2300E. As noted, the child phantom, when scraping the third party system initially determines if a stopclock is present for the target. If so, then no additional stopclock event is needed. However, if no such event is in the third party system, the permissions for the target indicates the stopclock is valid and the target contact information exists for email, then an email contact (a stopclock event) may be communicated back to the child phantom. Alternatively, a phone call event is communicated back to the child phantom.

Between the shared phantom class and the messaging systems API, the core functions are interposed, as seen generally at 2300F of FIG. 23F. Core functions behave as go-betweens for the shared phantom class and the API. When the shared phantom class calls a function, the core functions contacts the appropriate API which generates the applicable response in a manner understandable by the shared phantom class.

In a similar manner, the child phantom class requires an object to interact with the third party system. This object contains the properties of a webpage, such as cookies and headers. It also includes methods for opening new pages and evaluating these pages to collect information from within the third party system. These methods may include simple functions, or page behaviors.

There are many ways to open a page as described above. Two exemplary methods include the usage of a GET or POST parameters used to open a new webpage. The page is verified as elements are loaded until all elements are present. If, however, multiple pages need to be opened for a single task, then upon load completion an additional loading instruction may be employed/linked in order to claim page opening activity. After the page(s) have been opened the system may parse the pages to collect the desired information.

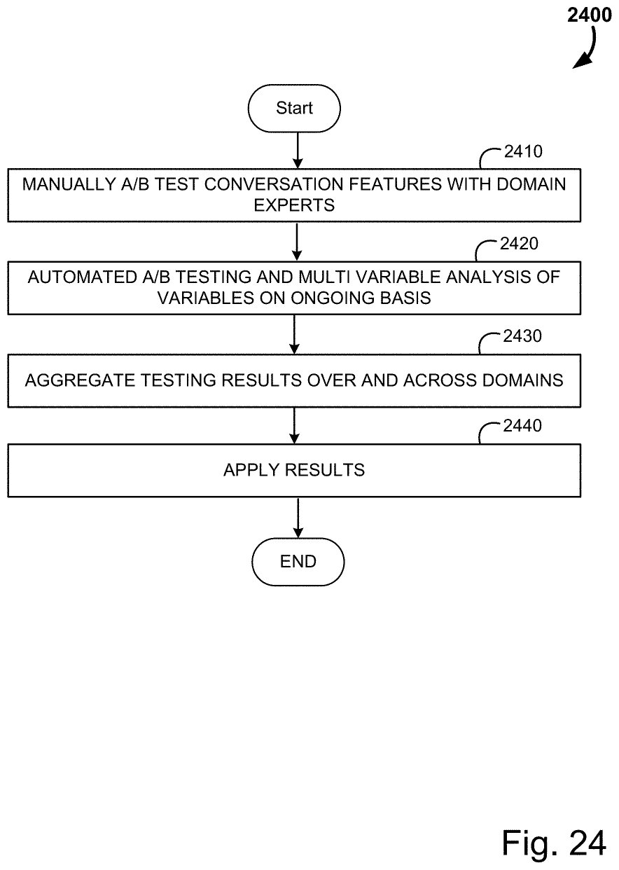

Moving on, FIG. 24 provides an example process for testing conversation variables, shown generally at 2400. As previously noted, the large scaled processing and sending of messages provides a fertile ground for variable testing to determine what activities are most effective to achieve an organizational goal. At first, the variables may be identified by the user, and manually testes (at 2410) by domain experts to generate the initial ‘best guess’ of the most effective variables. For example, a message sent from a doctor's office may generate better medication compliance, in the experience of the physician, if the patient is contacted within a couple days of having a new prescription filled with a message addressed from the patient's doctor (as opposed to a PA or nurse). After the baseline variables have been thusly determined, the system may initiate small variable changes between messages, and metrics associated with the goal may be compiled and used to determine which variables have a statistically significant impact upon the goal (at 2420).

For example, returning to the above example, assume the initial messages were sent two days after a prescription was provided to the patient. The system could start varying the time of day, or which day the email is sent to the patients. Collected data from the physician's electronic health record system (a third party system that may be scraped by the phantoms) may be used to determine how well the patients adhere to their medication regiments. Over time, the system may learn that a delay of three days, for example, is more effective, and this aggregated testing result may be applied to the instant case, and even across domains to other similar situations (at 2430). For example, a car dealership may experiment using this data to contact a new purchaser of a vehicle about an extended warranty product after a similar three day delay period. In this manner the results of the testing may be applied (at 2440) both in the original context of the testing, and to the degree it is shown to be effectuations, to other domains.

### III. System Embodiments

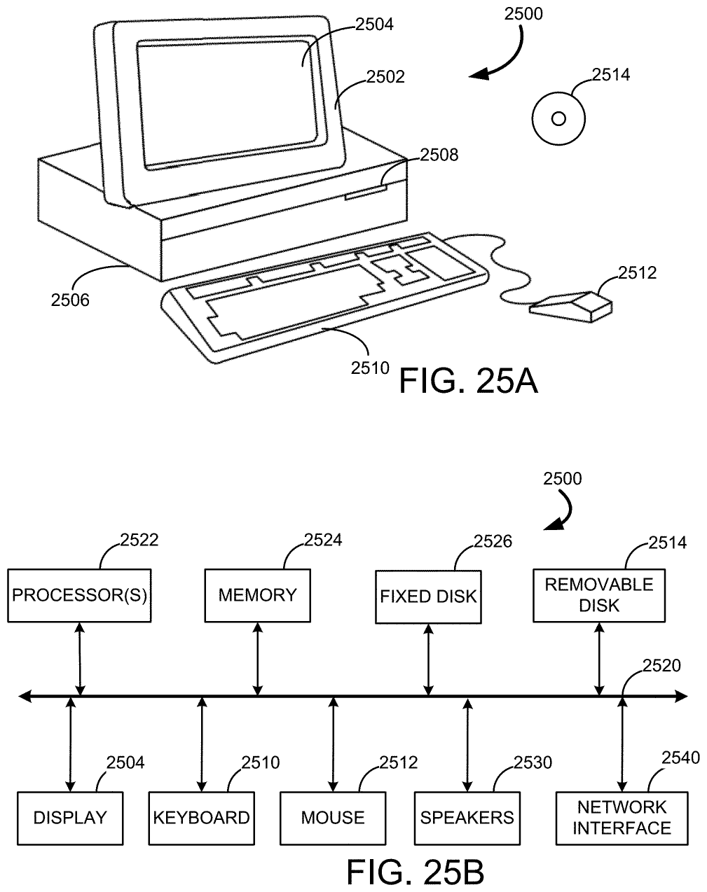

Now that the systems and methods for the conversation generation with improved functionalities have been described, attention shall now be focused upon systems capable of executing the above functions. To facilitate this discussion, FIGS. 25A and 25B illustrate a Computer System 2500, which is suitable for implementing embodiments of the present invention. FIG. 25A shows one possible physical form of the Computer System 2500. Of course, the Computer System 2500 may have many physical forms ranging from a printed circuit board, an integrated circuit, and a small handheld device up to a huge super computer. Computer system 2500 may include a Monitor 2502, a Display 2504, a Housing 2506, a Storage Drive 2508, a Keyboard 2510, and a Mouse 2512. Storage 2514 is a computer-readable medium used to transfer data to and from Computer System 2500.

FIG. 25B is an example of a block diagram for Computer System 2500. Attached to System Bus 2520 are a wide variety of subsystems. Processor(s) 2522 (also referred to as central processing units, or CPUs) are coupled to storage devices, including Memory 2524. Memory 2524 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Storage 2526 may also be coupled bi-directionally to the Processor 2522; it provides additional data storage capacity and may also include any of the computer-readable media described below. Fixed Storage 2526 may be used to store programs, data, and the like and is typically a secondary storage medium (such as a hard disk) that is slower than primary storage. It will be appreciated that the information retained within Fixed Storage 2526 may, in appropriate cases, be incorporated in standard fashion as virtual memory in Memory 2524. Removable Storage 2514 may take the form of any of the computer-readable media described below.

Processor 2522 is also coupled to a variety of input/output devices, such as Display 2504, Keyboard 2510, Mouse 2512 and Speakers 2530. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 2522 optionally may be coupled to another computer or telecommunications network using Network Interface 2540. With such a Network Interface 2540, it is contemplated that the Processor 2522 might receive information from the network or might output information to the network in the course of performing the above-described dynamic messaging processes. Furthermore, method embodiments of the present invention may execute solely upon Processor 2522 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 2500 can be controlled by operating system software that includes a file management system, such as a storage operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a virtual machine, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for return on investment (ROI) analysis comprising:
collecting a plurality of ROI metrics for an automated conversation;
comparing the number of each of the plurality of ROI metrics against a threshold for the given metric to identify a subset of metrics over the thresholds;
sorting the subset of metrics by total count of each metric multiplied by a weight associated with each metric; and
displaying the metrics to a user in order of the sorting.

2. The method of claim 1, wherein the ROI metrics include total numbers of appointments set, number of targets being actively managed, number of response messages sent, engagement rates, amount of contact information received, and number of messages sent per response.

3. The method of claim 1, wherein each threshold is dependent upon the ROI metric it is associated with.

4. The method of claim 1, wherein the thresholds are preconfigured.

5. The method of claim 4, wherein the thresholds are linearly dependent upon the total number of conversations being handled for a given client.

6. The method of claim 1, wherein the weights are preconfigured.

7. The method of claim 1, wherein the weights indicate a perceived importance of the particular ROI metric.

8. The method of claim 1, wherein the displaying includes selecting a subset of the top sorted metrics.

9. The method of claim 8, wherein the subset is a preconfigured number of ROI metrics.

10. The method of claim 1, wherein the displaying includes selecting a subset of the sorted metrics that is randomized each time a user views the display.

11. A system for return on investment (ROI) analysis comprising:
a metric compiler for collecting a plurality of ROI metrics for an automated conversation;
a display determiner for comparing the number of each of the plurality of ROI metrics against a threshold for the given metric to identify a subset of metrics over the thresholds, and sorting the subset of metrics by total count of each metric multiplied by a weight associated with each metric; and
a reporter for displaying the metrics to a user in order of the sorting.

12. The system of claim 11, wherein the ROI metrics include total numbers of appointments set, number of targets being actively managed, number of response messages sent, engagement rates, amount of contact information received, and number of messages sent per response.

13. The system of claim 11, wherein each threshold is dependent upon the ROI metric it is associated with.

14. The system of claim 11, wherein the thresholds are preconfigured.

15. The system of claim 14, wherein the thresholds are linearly dependent upon the total number of conversations being handled for a given client.

16. The system of claim 11, wherein the weights are preconfigured.

17. The system of claim 11, wherein the weights indicate a perceived importance of the particular ROI metric.

18. The system of claim 11, wherein the displaying includes selecting a subset of the top sorted metrics.

19. The system of claim 18, wherein the subset is a preconfigured number of ROI metrics.

20. The system of claim 11, wherein the displaying includes selecting a subset of the sorted metrics that is randomized each time a user views the display.
